(19) United States
(12) Patent Application Publication
(10) Pub. No.: US 2007/0156528 A1
(43) Pub. Date: Jul. 5, 2007

(54) On-line coupon distribution system

(75) Inventors: Jason C. Hopp, Bloomington, MN (US); John R. Decker III, Lakeville, MN (US)

Correspondence Address: NIKOLAI & MERSEREAU, P.A., 900 SECOND AVENUE SOUTH, SUITE 820, MINNEAPOLIS, MN, 55402, US

(73) Assignee: Ideals, Inc., Bloomington, MN (US)

(21) Appl. No.: 11/646,849

(22) Filed: Dec. 28, 2006

Related U.S. Application Data
(60) Provisional application No. 60/754,833, filed on Dec. 29, 2005.

(51) Int. Cl. G06Q 30/00

(52) U.S. Cl. 705/14

(57) ABSTRACT

A web-based application allowing registered MEMBERs to search for and print promotional coupons offered by ADVERTISERs who have the capability to design the terms of such coupons, as well as their graphic design. The relational database management system and software employed allows for registration of users as MEMBERs and ADVERTISERs. It further includes a flexible billing system, allowing users to select a plan best fitting the individual subscriber. Coupon offers are made MEMBER-searchable by an ADVERTISER's company name, type of business (category) and search phrases found in the text of the coupons. Coupons located in the search can be grouped in a virtual “coupon caddy” and subsequently printed out at a MEMBER's workstation computer printer.

### CROSS-REFERENCE TO RELATED APPLICATION

The present utility patent application is based upon and claims priority to provisional patent application Ser. No. 60/754,833, filed Dec. 29, 2005, and entitled “On-Line Coupon Distribution System”, the contents of which are hereby incorporated by reference.

### BACKGROUND OF THE INVENTION

1. Field of the Invention

This invention relates generally to the use of advertising coupons by merchants to promote the sale of goods and services, and more particularly to a method of electronic production and distribution of promotional coupons taking advantage of the communications capabilities of the worldwide web.

2. Discussion of the Prior Art

Merchants have, for many years, used promotional coupons to be used by customers in promoting the sale of goods and services. For example, a restaurant business may distribute coupons offering a discount on meals as an inducement for new customers to come in and dine. In the past, such coupons were typically made available through mass mailings or through newspaper advertising. Most everyone is familiar with coupon promotions used by grocery stores that provide money off the purchase price of products sold through the grocery store. If one is to take advantage of a discount, he/she must first clip the coupon from a newspaper or other mail pieces arriving at the consumer's home.

Readers will recognize that the merchant must deal with a commercial printer and with a direct mail organization to produce and distribute advertising pieces incorporating the coupons. The conventional method of printing and distributing promotional coupons is comparatively costly and somewhat ineffective given the number of consumers who choose not to avail themselves of the merchant's discount.

Accordingly, a need exists for a method of distributing promotional coupons where the merchant has the ability to define the terms of the offer and where potential consumers can readily access and print out only those coupons that are of interest to the potential consumer.

Privacy is also a concern of most consumers and they may be reluctant to participate in a coupon offer method that gathers demographic information on individuals for targeting such individuals with special offers, such as is described in the DeLapa et al. U.S. Pat. No. 6,954,732. Such tracking may discourage potential customers from availing themselves of coupon offerings from merchants based on privacy issues.

The Okamura et al. U.S. Pat. No. 6,880,715 describes a method for issuing coupons using an automatic transaction machine located at the merchant's site. The method of '751 patent allows one of a plurality of recording media to be chosen as an output medium of coupon information when a coupon is issued from a coupon service provider and the output medium is then read or otherwise processed by an ATM at the merchant's location. The system thus requires a complex network of special-purpose machines to affect the printing and distribution of promotional coupons.

From what has been said, it is apparent then that a need exists for coupon delivery system that does not solicit or divulge customer demographic information and that does not require anything other than a PC at a merchant and user location and that can communicate over a network, such as the world-wide web, with a server owned and controlled by a coupon administrator. Other desirable attributes of an automated coupon production and distribution system include the ability of advertisers to design their own coupons, including any special terms of the offer, the incorporation of business and/or product logos or other graphics and the ability to establish a number of categories indicating the general nature of the business. Potential customers must have the ability to search by category name, company name and coupon description within a defined geographic area, such as by postal code or city name. The customer should also be able to limit search results within a selected number of miles from a postal code or city.

### SUMMARY OF THE INVENTION

In accordance with the method of the present invention there is provided a host computer in communication with a plurality of remotely located workstations over a network, the workstations being disposed at both a merchant's and a customer's location. The host computer of the system ADMINISTRATOR incorporates a conventional memory with access to one or more databases that includes a plurality of tables, each table defining a set of screens viewable at the workstations and soliciting data to be entered by the system users from their workstations. For example, the screens may solicit a user's login name, a password, a postal address, an e-mail address, a user role I.D. indicative of whether the user is a merchant or a customer and the terms of a merchant's coupon offer. The data entered on the screens is then stored in the database for subsequent display and printout of promotional coupons at a workstation of registered customer.

As a further feature of the method of the present invention, the set of screens viewable at the workstations solicit further data for entry by system users that includes merchants' business type, merchants' business names, products/services of such businesses whereby a customer at a workstation can perform the step of searching the database for keywords and for a geographic distance between a location of a merchant's facility and a customer's designated location related to the postal address entered by that customer.

Further features, objects and advantages of the invention will become apparent to those skilled in the art from the following detailed description of a preferred embodiment, especially when considered in conjunction with the accompanying drawings which illustrate the invention by way of example.

### BRIEF DESCRIPTION OF THE DRAWINGS

FIG. 1 is a general block diagram of the on-line coupon distribution system in accordance with the present invention;

FIG. 2 is a relational database table pertaining system users and user roles;

FIG. 3 is a database table showing how billing plans and promotions are associated with different possible user roles;

FIG. 4 illustrates the database tables pertaining to users and payment aspects of the system;

FIG. 5 illustrates the database tables pertaining to the fundraising feature;

FIG. 6 shows the database tables pertaining to charitable giving;

FIG. 7 shows the relational database tables implementing special data tracking for users having ADVERTISER roles;

FIG. 8 illustrates the database tables associating with users to geographical locations;

FIG. 9 shows the relational database tables facilitating franchising;

FIG. 10 shows the relational database tables relating to creation and distribution of promotional coupons;

FIG. 11 shows the relational database tables implementing an advertising function;

FIG. 12 shows the database tables pertaining to searching and word filtering;

FIG. 13 illustrates the database tables facilitating the inclusion of logos and other graphics on coupons;

FIG. 14 illustrates the relational database tables for gathering usage statistics;

FIG. 15 depicts the relational database tables implementing the coupon caddy function;

FIG. 16 is a programming flow chart of the database management software relating to the new coupon wizard;

FIG. 17 is a software flow chart relating to coupon date validation;

FIG. 18 is a software flow chart relating to coupon display date calculations;

FIG. 19 is a software flow diagram relating to user authentication;

FIG. 20 is a software flow diagram of the algorithm relating to user registration;

FIG. 21 is a software flow diagram relating to the e-mail validation process;

FIG. 22 is a software flow diagram for a billing process algorithm;

FIG. 23 is a software flow diagram of an algorithm for effecting changes to a billing plan;

FIG. 24 is a software flow diagram illustrating the algorithm involved in automatic renewal and billing of system users; and

FIG. 25 is a software flow diagram implementing the ability to search for specific wording in coupons.

### DESCRIPTION OF THE PREFERRED EMBODIMENT

Persons skilled in the art of the present invention will have an in-depth understanding of relational database systems for recording and maintaining information. This understanding will include the cardinality rules which the data must obey. A person skilled in the art will also have knowledge of Entity Relationship (ER) modeling, i.e., the graphical representation of a database system and that is composed of entities, attributes and relationships. Especially important is the ability to discern and map parallel relationships in that the tabular presentation set forth in the following specification presumes knowledge of the mapping of ER models into relations.

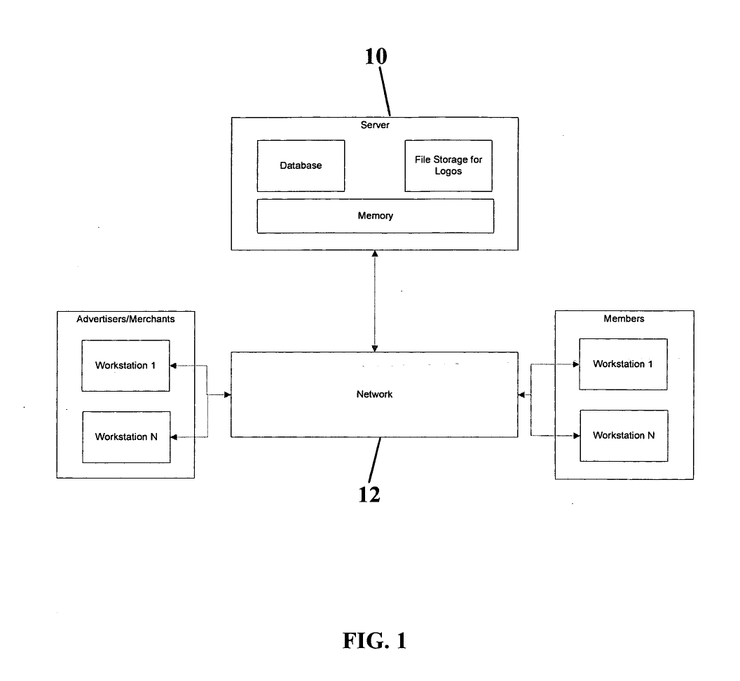

Referring to FIG. 1, there is illustrated a system diagram of the apparatus employed in carrying out the method of the present invention. The system administrator has a network server such as web server that has access to a database server comprising a computer and storage device that is dedicated to storing and processing database queries. The server computer is identified by numeral 10 in FIG. 1. The network 12 may comprise a worldwide web or, conceivably could comprise a private network.

Coupled to the network 12 is a plurality of workstations labeled “Workstation 1” through “Workstation N”. They may be dedicated PCs owned by ADVERTISERs and by MEMBERs. As used herein, an ADVERTISER, sometimes referred to as merchant, is a user whose role can create coupons, offers and ads in the system. A MEMBER, on the other hand, is a user whose role is to search for coupons and offers from users having an ADVERTISER role. The ADMINISTRATOR role allows a user to update configuration aspects of the system and has the ability to create and update users of all the possible roles. For example, a CORPORATE BENEFIT role affords a user the ability to designate other submembers and it is intended to be used as an employee benefit for corporations. Users designated as having the CORPORATE BENEFIT role are able to terminate MEMBERs of their submembers. Once canceled, a previous submember is prompted to upgrade his account to a personal membership.

The system further recognizes a FUNDRAISER role where users so designated may typically be coordinators of school or team fundraisers. They will be able to access the system to set up rules of their fundraisers and to get reports on how MEMBERs have signed up and are associated with their fundraiser.

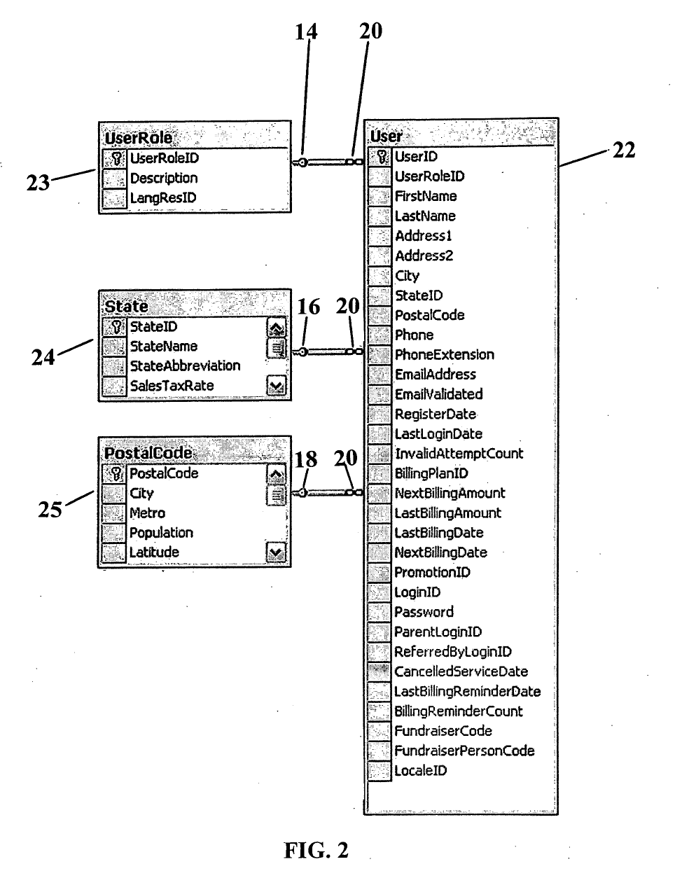

Referring to FIG. 2, it is a database table pertaining to users and roles. The symbol 14, i.e., a circle on an input/output line between two database tables, is used to illustrate that a user is associated with one and only one user role. This implies that if a person wishes to be both an ADVERTISER and a MEMBER, he must have two different accounts. Similarly, the symbols 16 and 18 illustrate that a user is associated with one and only one State and Postal Code. The infinity symbols 20 (∞) on the diagram of FIG. 2, being adjacent a table, is indicative that many possible users can be registered in the database but, as mentioned, a given user can only be associated with a single State and Postal Code. The system is capable of validating a user's input from his workstation against the associated tables and will reject the input if it does not match data in the State or Postal Code tables.

The relational database illustrated in FIG. 2 includes a user table 22 that is the central table in the system. It contains all of the users of the system and the related information about each user. Many user interface screens are impacted by the data in this table. Set forth below is a table more fully describing each entry in the user table 22 in terms of its type, e.g. integer (int), variable character (vachar), datetime, etc., its size, a brief description and whether required or not (yes/no).

| Column Name | Type | Size | Description | Required |
|---|---|---|---|---|
| UserID | Int | 4 | This is the unique ID in the | Yes |
| | | | system for Users. It is system | |
| | | | generated. | |
| UserRoleID | Int | 4 | This is the ID of the role | Yes |
| | | | associated with this user. For | |
| | | | example, this may designate this | |
| | | | user as a member, advertiser, | |
| | | | Fundraiser Account, etc. | |
| FirstName | Varchar | 30 | The user's First Name. In the | Yes |
| | | | case of a business, it is the | |
| | | | person responsible for the | |
| | | | account. | |
| LastName | Varchar | 50 | The user's Last Name. In the | Yes |
| | | | event of a business, it is the | |
| | | | person responsible for the | |
| | | | account. | |
| Address1 | Varchar | 80 | The user's address. Line 1 of 2. | Yes |
| Address2 | Varchar | 80 | The user's address. Line 2 of 2. | No |
| City | Varchar | 80 | The user's City. | Yes |
| StateID | Int | 4 | The user's State ID. The state | Yes |
| | | | text or abbreviation is not stored | |
| | | | here. Rather this is a foreign key | |
| | | | (FK) to the State table in the | |
| | | | system. | |
| PostalCode | Varchar | 10 | The user's Postal Code (Zip | Yes |
| | | | Code). This is used as the | |
| | | | default postal code to be used in | |
| | | | searches. | |
| Phone | Varchar | 10 | The user's Phone Number | Yes |
| PhoneExtension | Varchar | 50 | The user's Phone Number | No |
| | | | Extension. This will most likely | |
| | | | only be used if the user has given | |
| | | | his work number as the main | |
| | | | number in the system. | |
| EmailAddress | Varchar | 80 | The email address that will be | Yes |
| | | | used to send all notifications. The | |
| | | | user must validate this email | |
| | | | address after registering. The | |
| | | | system will send him an email | |
| | | | with a validation code that the | |
| | | | user must enter into the system | |
| | | | when logging in the first time after | |
| | | | registration. | |
| EmailValidated | Int | 4 | Flag indicating that the user has | Yes |
| | | | validated his email address. | |
| RegisterDate | datetime | 8 | The date that the user signed up | Yes |
| | | | for the service. This is never | |
| | | | updated after the user registers. | |
| LastLoginDate | datetime | 8 | The date the user last logged into | Yes |
| | | | the system. This is updated each | |
| | | | time the user authenticates with | |
| | | | the system. | |
| InvalidAttemptCount | Int | 4 | This is updated each time the | Yes |
| | | | user is unsuccessful when | |
| | | | logging in. The system will | |
| | | | require the administrator to reset | |
| | | | the user after 5 unsuccessful | |
| | | | attempts. If the user has tried | |
| | | | that many times, it usually | |
| | | | indicates a user is hacking into | |
| | | | the system and is a security | |
| | | | measure. | |
| BillingPlanID | Int | 4 | This is the billing plan associated | No |
| | | | with this user. It can be null (not | |
| | | | specified) if the user is taking part | |
| | | | in a no obligation promotion. If | |
| | | | this field is null, the system cannot | |
| | | | automatically bill the user. | |
| NextBillingAmount | Float | 8 | Based on the billing plan this is | No |
| | | | the amount the user will be billed | |
| | | | next. This can be over-ridden by | |
| | | | the administrator of the system. If | |
| | | | this field is null, the system cannot | |
| | | | automatically bill the user. | |
| LastBillingAmount | Float | 8 | The amount of the user's last | No |
| | | | billing. This is used for reporting | |
| | | | and as part of the calculation to | |
| | | | determine how much to bill the | |
| | | | user when the user changes his | |
| | | | billing plan. | |
| LastBillingDate | datetime | 8 | The date the user was last billed. | No |
| | | | The system records this when the | |
| | | | user makes a payment. If this is | |
| | | | null (not specified), the user has | |
| | | | not made a payment and is | |
| | | | probably taking part in a no | |
| | | | obligation promotion. This is | |
| | | | used in the reporting system and | |
| | | | used to calculate the new billing | |
| | | | amount when the user changes | |
| | | | his billing plan. | |
| NextBillingDate | datetime | 8 | This is the date when the user will | Yes |
| | | | be billed next. This is calculated | |
| | | | when the user registers with the | |
| | | | system as part of a no obligation | |
| | | | promotion or anytime the user is | |
| | | | billed. This will be used to limit | |
| | | | the user's access from the system | |
| | | | in the event that the system | |
| | | | cannot automatically bill the user's | |
| | | | credit card. | |
| PromotionID | Int | 4 | This is the promotion entered | No |
| | | | when the user registered with the | |
| | | | system. The user can only take | |
| | | | part in one automatic promotion. | |
| | | | Any other modifications to the | |
| | | | users billing plan as an incentive | |
| | | | to keep the user in the system | |
| | | | must be entered by the | |
| | | | administrator. | |
| LoginID | Varchar | 50 | This is the user's unique ID used | Yes |
| | | | to log into the system. The user | |
| | | | specifies this when registering. | |
| | | | The system enforces uniqueness. | |
| | | | That is, no user in the system | |
| | | | can have the same login ID as a | |
| | | | past or present user. | |
| Password | varchar | 50 | This is the user's password used | Yes |
| | | | to authenticate him with the | |
| | | | system. It is stored in the | |
| | | | database as a hashed value and | |
| | | | is not in plain text. Since it is a | |
| | | | hashed value, no-one, not even | |
| | | | the system administrator, can find | |
| | | | out another user's password. If | |
| | | | the user forgot his password, the | |
| | | | system will generate a new one | |
| | | | and email it to the user. The | |
| | | | system administrator cannot set | |
| | | | this field for any user. | |
| ParentLoginID | Varchar | 50 | This is a corporate user's | No |
| | | | associated corporation login ID. | |
| | | | That is, if a corporation has | |
| | | | bought a 10 user membership, up | |
| | | | to 10 other users of the system | |
| | | | will have the corporations LoginID | |
| | | | stored in this field. | |
| ReferredByLoginID | Varchar | 50 | It will store the login ID of another | No |
| | | | user in the system that referred | |
| | | | this user. | |
| CancelledServiceDate | datetime | 8 | This is the date when the user | No |
| | | | cancelled service. If it is null (not | |
| | | | specified), the user is still active. | |
| LastBillingReminderDate | datetime | 8 | If the system cannot bill the user | No |
| | | | for any reason, the system will | |
| | | | send out email notifications. This | |
| | | | is the last date the notification | |
| | | | was sent. | |
| BillingReminderCount | Int | 4 | The number of billing reminders | No |
| | | | the system has already sent. The | |
| | | | system will send up to 3 billing | |
| | | | reminders to attempt to get the | |
| | | | user to come back to system and | |
| | | | update his profile to fix whatever | |
| | | | problem is stopping the system | |
| | | | from automatically billing him. | |
| FundraiserCode | varchar | 20 | This is the fundraiser code the | No |
| | | | user enters during the registration | |
| | | | process. It will associate the | |
| | | | user's next billing with a | |
| | | | fundraiser. Once the system | |
| | | | prepares bills and associates a | |
| | | | billing with a fundraiser, this field | |
| | | | and the FundraiserPersonCode is | |
| | | | nulled. This means that | |
| | | | subsequent billings will not be | |
| | | | associated with a fundraiser. If | |
| | | | the user wants to renew and | |
| | | | associate his renewal billing with | |
| | | | a fundraiser the next year, he will | |
| | | | update his profile. | |
| FundraiserPersonCode | Varchar | 5 | This is the person's ID who | No |
| | | | referred the user to the system. | |
| LocaleID | Int | 4 | This is the person's Locale | No |
| | | | (language) in the system. Default | |
| | | | will be 1033 which is the Windows | |
| | | | Locale ID for United States | |
| | | | English. | |

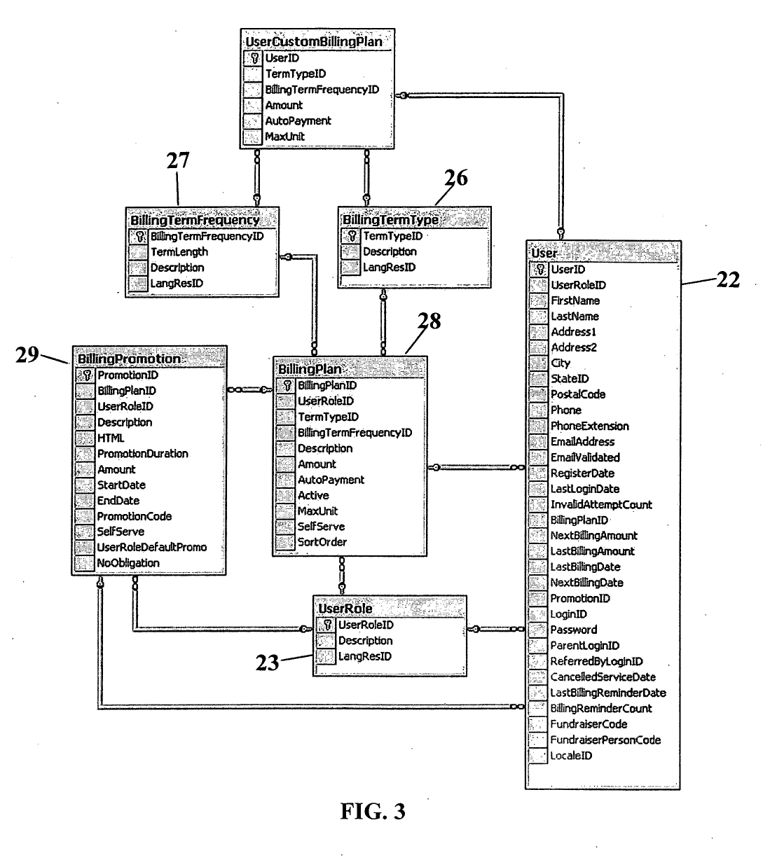

At the time of registration, the system automatically assigns a specific account number to each user who registers. Using this specific account number (also known as the “Referrer I.D.” or “Login I.D.”), a URL link may be created containing the specific existing user's I.D. for tracking purposes. The existing user may distribute this link to others or display it on their or other's websites. The system recognizes and records new users who arrive at the ADMINISTRATOR's site via clicking on an existing user's link containing their specific I.D., and therefore, allowing the ability to track the source of new users coming to the site referred from an existing user. This feature not only is excellent for tracking the source of new users, but can also be utilized in an affiliate and/or referral compensation program. The User Role table 23 in FIG. 3 comprises a system values table meaning that there are no user interfaces that will maintain the data in this table. If changes are required to this table, it will impact other areas of the system and cause programming changes to be necessary. The following table further describes the entries in the user role table.

| Column Name | Type | Size | Description | Required |
|---|---|---|---|---|
| UserRoleID | Int | 4 | This is the unique ID in the | Yes |
| | | | system for Roles. It is | |
| | | | system generated. | |
| Description | Varchar | 80 | This is the description of | Yes |
| | | | the role in the system | |

In a similar fashion, the State table 24 allows a user to choose the state in which they live from a drop-down menu populated by the values in this table. The several entries in the State table are defined as follows:

| Column Name | Type | Size | Description | Required |
|---|---|---|---|---|
| StateID | Int | 4 | ID that identifies this state | Yes |
| | | | uniquely in the system. | |
| | | | This is used as a FK into the User table. | |
| StateName | Varchar | 50 | Long name of the state | Yes |
| StateAbbreviation | Varchar | 2 | The 2 character US state | Yes |
| | | | abbreviation for this state. | |
| StateSalesTaxRate | Float | 8 | If this is non-null, the value is | No |
| | | | used in the billing process to | |
| | | | calculate the state sales tax. | |

The entries in the Postal Code table will have the following type, size and description and all of the parameters are required.

| Column | | | | |
|---|---|---|---|---|
| Name | Type | Size | Description | Required |
| PostalCode | Varchar | 10 | In the first revision of the | Yes |
| | | | web site, this will be a | |
| | | | US Zip Code in the form | |
| | | | of 99999 or 99999-9999 | |
| City | Varchar | 80 | The city associated | Yes |
| | | | with this zip. | |
| Population | Int | 4 | The population associated | Yes |
| | | | with this zip. | |
| Latitude | Int | 4 | The latitude associated with | Yes |
| | | | this zip. This field is | |
| | | | used to calculate | |
| | | | the distance between two zip | |
| | | | codes and is used in the | |
| | | | searching process of the site. | |
| Longitude | Int | 4 | The longitude associated | Yes |
| | | | with this zip. This field is | |
| | | | used to calculate | |
| | | | the distance between two zip | |
| | | | codes and is used in the | |
| | | | searching process of the site. | |

FIG. 3 is a database table showing how billing plans and promotions are associated with the different possible user roles. For example, a billing plan for an ADVERTISER is separate and distinct from billing plans for MEMBERs.

The present invention contemplates that there will be three basic types of billing plans. In a first, there is a Fee-Based billing cycle. This billing plan assumes that the user pays a flat rate fee for access to the system. His/her access can be made subject to limitations. For example, an ADVERTISER plan may limit the number of coupons to, say, three, meaning the maximum number of active coupons that an ADVERTISER can have set up in the system at any one time in three. Alternatively, a MEMBER plan may limit the number of coupons printed to, say, two hundred. The system will automatically bill the user for his/her usage and limit usage to settings in other parts of the billing plan data. The second type of billing plan may be called Usage-Based. Here, the billing plan does not limit the user's usage, but rather bills the user based on how much he/she has used the system over a period of time. For example, a MEMBER plan could charge the user a penny for each coupon that he/she prints. In another example, an ADVERTISER plan may allow them to set up as many coupons as they wish and charge them for each coupon that a MEMBER actually prints. The third billing plan contemplated is where there is no billing. This may be used for users of the system who are not to be charged for such usage. An ADMINISTRATOR account would fall into this category.

Billing plans are also associated with a billing frequency. Monthly, quarterly, yearly and not-billed plans are contemplated. It logically follows that for Fee-Based billing plans, amounts to be billed are determined in advance of actual usage. For Usage-Based billing plans, a user will typically be billed at the end of a month for usage in the preceding month. Quarterly billing is the same as monthly billing except it will occur every three months. Yearly billing is the same as monthly billing except that billing occurs once a year.

The tables immediately below suggest the terms of possible billing plans. As will be explained further herein below, the ADMINISTRATOR of the system is able to modify the billing plans in place at any time.

| | | | | | Printed |
|---|---|---|---|---|---|
| | | | | | Coupon |
| Role | Description | Cycle | Type | Amount | Limit |
| MEMBER | Personal membership - Billed | Monthly | Fee-Based Billing | $5.00 | None |
| | Monthly | | Cycle | | |
| MEMBER | Personal membership - Billed | Quarterly | Fee-Based Billing | $10.00 | None |
| | Quarterly | | Cycle | | |
| MEMBER | Personal membership - Billed | Yearly | Fee-Based Billing | $20.00 | None |
| | Yearly | | Cycle | | |
| MEMBER | Corporate membership | Not Billed | Fee-Based Billing | $— | None |
| | | | Cycle | | |

| | | | | | Active |
|---|---|---|---|---|---|
| | | | | | Coupon |
| Role | Description | Cycle | Type | Amount | Limit |
| Advertiser | Monthly membership Fee (0-3 | Monthly | Fee-Based Billing | $20.00 | 3 |
| | Coupons) | | Cycle | | |
| Advertiser | Quarterly membership Fee (0-3 | Quarterly | Fee-Based Billing | $50.00 | 3 |
| | Coupons) | | Cycle | | |
| Advertiser | Yearly membership Fee (0-3 | Yearly | Fee-Based Billing | $200.00 | 3 |
| | Coupons) | | Cycle | | |
| Advertiser | Monthly membership Fee (0-5 | Monthly | Fee-Based Billing | $30.00 | 5 |
| | Coupons) | | Cycle | | |
| Advertiser | Quarterly membership Fee (0-5 | Quarterly | Fee-Based Billing | $80.00 | 5 |
| | Coupons) | | Cycle | | |
| Advertiser | Yearly membership Fee (0-5 | Yearly | Fee-Based Billing | $350.00 | 5 |
| | Coupons) | | Cycle | | |
| Advertiser | Monthly Printed Coupon Fee | Monthly | Usage-Based Billing | $0.10 | None |
| | | | Cycle | | |

| | | | | | Sub |
|---|---|---|---|---|---|
| | | | | | Account |
| Role | Description | Cycle | Type | Amount | Limit |
| Corporate | Corporate Benefit membership (0-10) | Yearly | Fee-Based Billing | $100.00 | 10 |
| Benefit | memberships | | Cycle | | |
| Corporate | Corporate Benefit membership (0-20) | Yearly | Fee-Based Billing | $150.00 | 20 |
| Benefit | memberships | | Cycle | | |
| Corporate | Corporate Benefit membership (0-50) | Yearly | Fee-Based Billing | $300.00 | 50 |
| Benefit | memberships | | Cycle | | |
| Corporate | Corporate Benefit membership (0-100) | Yearly | Fee-Based Billing | $1,000.00 | 100 |
| Benefit | memberships | | Cycle | | |
| Corporate | Corporate Benefit membership | Yearly | Fee-Based Billing | $2,000.00 | −1 |
| Benefit | Unlimited memberships | | Cycle | | |
| Corporate | Corporate Benefit membership Per | Yearly | Usage-Based Billing | $5.00 | −1 |
| Benefit | User Billing | | Cycle | | |

FIG. 3 is a database table pertaining to billing and promotions. From the meaning of the symbols set forth on page 13, it can be observed that a user can have just a single billing plan and is able to use one and only one promotion. The promotion that a user uses during the registration step is recorded for tracking, reporting and historical purposes. Billing plans and promotions are associated to specific roles in the system. The User Database table 22 in FIG. 3 is identical in all respects to the User Database table 22 in FIG. 2.

The Billing Term Type table 26 is a system values table, meaning that there are no user interfaces that will maintain the data in this table. If changes are required to this table, it will impact other areas of the system and cause programming changes to be necessary. The table immediately below particularizes the entries in the Billing Term Type table 26.

| Column | | | | |
|---|---|---|---|---|
| Name | Type | Size | Description | Required |
| TermTypeID | Int | 4 | ID that identifies a Type | Yes |
| | | | of billing term in the system. | |
| Description | Varchar | 80 | The Description of this | Yes |
| | | | term | |

The Billing Term Frequency table 27 is also a System Values table necessitating programming changes in the event that changes are required in this table. The constraints on the type, size and requirements for the database entries in the Billing Term Frequency table 27 are set out immediately below.

| Column Name | Type | Size | Description | Required |
|---|---|---|---|---|
| BillingTermFrequencyID | Int | 4 | ID that identifies the frequency that | Yes |
| | | | a user will be billed in the system. | |
| TermLength | Int | 4 | The length in months a user is | Yes |
| | | | billed. Monthly = 1, Quarterly = 3, | |
| | | | Yearly = 12, Not Billed = −1 | |
| Description | Varchar | 80 | The description of this frequency | Yes |

The Billing Plan table 28 gives the ADMINSTRATOR a user interface that allows data in this table to be edited. Again, the several entries in this table are further particularized in the following table.

| Column Name | Type | Size | Description | Required |
|---|---|---|---|---|
| BillingPlanID | Int | 4 | This is a unique ID in the table that | Yes |
| | | | identifies a billing plan. This is used | |
| | | | as a FK value in the User table to | |
| | | | associate a user with a billing plan. | |
| UserRoleID | Int | 4 | The type of user that can be assigned | Yes |
| | | | to this billing plan. (Member, | |
| | | | Advertiser, Corp Benefit etc) | |
| TermTypeID | Int | 4 | The type of terms for this plan. Fee | Yes |
| | | | based or Usage based (or free). | |
| Amount | float | 8 | This is the amount of US Dollars that | Yes |
| | | | will be charged to a users credit card. | |
| AutoPayment | int | 4 | A flag indicating whether or not this | Yes |
| | | | plan can be automatically billed to a | |
| | | | users payment account. This is | |
| | | | nonzero for any type of plan that is not free | |
| Active | int | 4 | A flag indicating whether or not this | Yes |
| | | | plan is active. Plans will never be | |
| | | | deleted from the system. Rather, they | |
| | | | will simply be made inactive which will | |
| | | | keep new users from selecting them | |
| | | | during the registration process. These | |
| | | | rows cannot be deleted because of | |
| | | | database integrity. | |
| MaxUnit | int | 4 | Based on the type of plan, this is the | Yes |
| | | | maximum system usage for a user. | |
| | | | This is system enforced and varies | |
| | | | depending upon the role and Term | |
| | | | Type selected. −1 indicates there is no | |
| | | | max usage associated with this plan. | |
| SelfServe | int | 4 | A flag indicating if this billing plan is | Yes |
| | | | visible during the user's registration | |
| | | | process. Some billing plans will be | |
| | | | active in the system and will only be | |
| | | | able to be assigned by the | |
| | | | Administrator. | |
| SortOrder | Int | 4 | The order in which these plans will be | No |
| | | | displayed to the user during | |
| | | | registration and the billing upgrade | |
| | | | process. | |

With continued reference to FIG. 3, the Billing Promotion table 29 affords the ADMINISTRATOR a user interface allowing data in this table to be edited.

| Column Name | Type | Size | Description | Required |
|---|---|---|---|---|
| PromotionID | Int | 4 | This is a unique ID in the table | Yes |
| | | | that identifies a promotion. This | |
| | | | is used as a FK value in the User | |
| | | | table to identify what promotion | |
| | | | was used to get this user to | |
| | | | register in the system. | |
| BillingPlanID | int | 4 | This is the billing plan associated | Yes |
| | | | with this promotion. A promotion | |
| | | | must always be associated with | |
| | | | a billing plan that the user agrees | |
| | | | to sign up for when accepting | |
| | | | this promotion. The promotion | |
| | | | can still be “No Obligation”, but if | |
| | | | the user chooses to stay with the | |
| | | | system, this is the billing plan | |
| | | | they are committed to. | |
| UserRoleID | Int | 4 | The user role (member, | Yes |
| | | | advertiser etc) that this | |
| | | | promotion is targeted at. | |
| Description | Varchar | 80 | The description of the promotion | Yes |
| HTML | Varchar | 8000 | HTML that is used in the User | No |
| | | | Interface to display to the user | |
| | | | information about this promotion. | |
| | | | This is typically only used for self | |
| | | | service promotions and | |
| | | | promotions that are the “default” | |
| | | | promotions for the user role. If | |
| | | | this field is null (not specified), | |
| | | | the User Interface will not allow | |
| | | | the promotion to be a default | |
| | | | self-service promotion. | |
| PromotionDuration | Int | 4 | This is how long a promotion will | Yes |
| | | | allow the user to access the | |
| | | | system. For example, first | |
| | | | month free, with no obligation will | |
| | | | allow a member to access the | |
| | | | system free for a month. If a | |
| | | | billing plan is associated with this | |
| | | | promotion, the duration is added | |
| | | | to the frequency to calculate the | |
| | | | “NextBillingDate” field in the user | |
| | | | table. For example, if the | |
| | | | promotion is 1 month free with a | |
| | | | year membership, the next billing | |
| | | | date will be 13 months from the | |
| | | | day the user registered. | |
| Amount | Float | 8 | This is the amount of US Dollars | Yes |
| | | | that will be charged to the user's | |
| | | | credit card if they select this | |
| | | | promotion. Any amount here is | |
| | | | added to a related billing plan. | |
| | | | That is, if the promotion was | |
| | | | something like 1st month $5.00 | |
| | | | with a year membership. The | |
| | | | $5.00 would be added to the | |
| | | | amount of the billing plan when | |
| | | | the user credit card was | |
| | | | charged. | |
| StartDate | Datetime | 8 | This is the date that the | No |
| | | | promotion will start to be active. | |
| | | | A null value here, indicates that | |
| | | | this promotion is currently active. | |
| EndDate | datetime | 8 | This is the date that the | No |
| | | | promotion will end. A null value | |
| | | | here, indicates that this | |
| | | | promotion never ends. | |
| PromotionCode | varchar | 20 | This is a code that can be used | No |
| | | | in a marketing campaign to track | |
| | | | which users register in the | |
| | | | system. It can be a more user | |
| | | | friendly way to identify the | |
| | | | promotion other than the | |
| | | | PromotionID field. It is a unique | |
| | | | field enforced by the database. | |
| | | | The registration user interface | |
| | | | will allow users to enter this code | |
| | | | to take advantage of “hidden” or | |
| | | | non-self-serve promotions in the | |
| | | | system. | |
| SelfServe | int | 4 | A flag that indicates that this | Yes |
| | | | promotion is visible to the user | |
| | | | during the registration process. | |
| | | | It will give the user an incentive | |
| | | | to join the system today without | |
| | | | being mailed a specific | |
| | | | marketing piece. | |
| UserRoleDefaultPromo | int | 4 | A flag that indicates that this | Yes |
| | | | promotion is visible in the | |
| | | | “marketing” area of a user's role | |
| | | | page in the User Interface. | |
| NoObligation | int | 4 | A flag that indicates that this | Yes |
| | | | promotion does not require the | |
| | | | user to input his credit card | |
| | | | information during the | |
| | | | registration process. Default | |
| | | | value is 0 meaning that a credit | |
| | | | card is required. | |

The system allows payments to be made automatically at specified times dictated by the particular user's billing plan. It is contemplated that payments may be authorized and processed through the well-known website, Authorized.Net. It allows a merchant to submit a credit card transaction to the Authorized.Net Payment Gateway on behalf of a customer via a secure connection from a website. The transaction is then passed on to the Merchant Bank's processor. That processor then submits the transaction to the Credit Card Interchange (a network of financial entities that communicate to manage the processing, clearing and settlement of credit card transactions). Ultimately, the Credit Card Interchange passes the appropriate funds for the transaction to the ADMINISTRATOR's account at Merchant's Bank, which then deposits funds into the Merchant's Bank.

The system will allow the ADMINISTRATOR to determine the payment methods accepted by the system. For example, the ADMINISTRATOR may determine that it only wishes to accept VISA and MasterCard transactions because fees charged by American Express, for example, may be considered excessive.

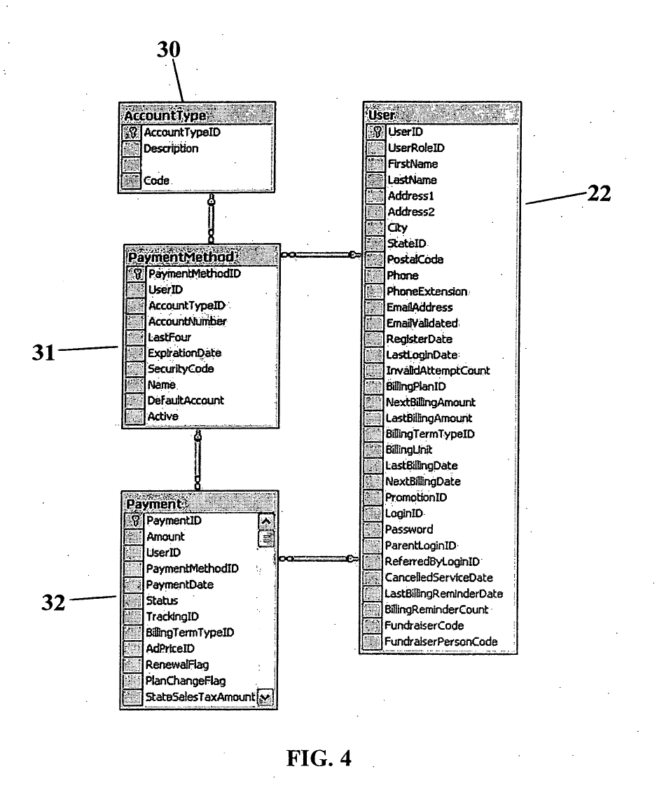

FIG. 4 illustrates the database tables pertaining to users and roles.

The following table describes the data stored in the database tables of FIG. 4. The User Table 22 has already been described and there is no need to repeat the description of that table.

The Account Type table 30 is a system values table meaning that there are no user interfaces that will maintain the data in this table. If changes are required to this table, it will impact other areas of the system and cause programming changes to be necessary.

| Column Name | Type | Size | Description | Required |
|---|---|---|---|---|
| AccountTypeID | int | 4 | System ID used to | Yes |
| | | | identify an | |
| | | | account of this type. | |
| Description | varchar | 50 | Description of this | Yes |
| | | | payment method. | |
| | | | Example: Visa, | |
| | | | MasterCard | |
| Code | varchar | 50 | The Authorize.net code | Yes |
| | | | associated with | |
| | | | this type of account. | |

The Payment Method table 31 in FIG. 4 affords users the ability to set up and manage their own payment methods. Only one payment method can be used, by default, for the Automated Billing Process. This is sensitive data and the account number is stored, encrypted for protection from database ADMINISTRATORS and other users in the system.

| Column Name | Type | Size | Description | Required |
|---|---|---|---|---|
| PaymentMethodID | int | 4 | This is a unique ID identifying this | Yes |
| | | | payment method in the system. It is | |
| | | | system generated and cannot be | |
| | | | edited directly by the user. | |
| UserID | int | 4 | This is the user who owns this | Yes |
| | | | payment account. | |
| AccountTypeID | int | 4 | This is the type of account. Visa, | Yes |
| | | | MasterCard etc. | |
| AccountNumber | varchar | 96 | This is the encrypted value of the | Yes |
| | | | credit card number. This is only | |
| | | | unencrypted during the transmission | |
| | | | of data with Authorize.net and is done | |
| | | | over a secure socket connection. | |
| LastFour | char | 4 | This is the last four digits of the | Yes |
| | | | account number so that the user can | |
| | | | identify the card when viewing it in | |
| | | | the User Interface. | |
| ExpirationDate | datetime | 8 | The expiration date of the credit card | Yes |
| SecurityCode | varchar | 5 | The 3 digit security code printed on | Yes |
| | | | the back of the credit card. | |
| Name | varchar | 80 | The name on the card. It can be | Yes |
| | | | different from the user's name. | |
| DefaultAccount | int | 4 | A flag indicating if this is the card to | Yes |
| | | | be used in the automated billing | |
| | | | process. | |
| Active | int | 4 | A flag that indicates if this card is | Yes |
| | | | active. This is important because | |
| | | | when the user changes aspects of | |
| | | | his credit card, the previous payment | |
| | | | method is made inactive and all the | |
| | | | data created into a new payment | |
| | | | account. This is done so that the | |
| | | | exact credit card information used in | |
| | | | the payment system can be | |
| | | | historically kept accurate. | |

The Payment Table 32 in FIG. 4 is the actual payment tracking table. All transactions between the Authorized.Net system and the particular site are tracked in this table.

| Column Name | Type | Size | Description | Required |
|---|---|---|---|---|
| PaymentID | int | 4 | System ID used to identify this | Yes |
| | | | payment in the system. It cannot be | |
| | | | modified once created. | |
| Amount | float | 8 | The total amount of the payment | Yes |
| | | | including any sales tax. | |
| UserID | int | 4 | The user ID who made the payment | Yes |
| PaymentMethodID | int | 4 | The payment account used to make | Yes |
| | | | the payment. | |
| PaymentDate | datetime | 8 | The date the payment was | Yes |
| | | | processed. | |
| Status | varchar | 50 | Status Code returned by | Yes |
| | | | Authorize.net | |
| TrackingID | varchar | 50 | Tracking ID returned by Authorize.net | Yes |
| BillingTermTypeID | int | 4 | If this was used for a standard billing, | No |
| | | | the type of billing (fee based, usage | |
| | | | based). This is used for reporting on | |
| | | | payment data. | |
| AdPriceID | int | 4 | If this was a payment for an ad | No |
| | | | placement, the AdPriceID (days, | |
| | | | months, quarters, etc). This is used | |
| | | | for reporting on payment data. | |
| RenewalFlag | int | 4 | A flag that indicates this payment for | Yes |
| | | | a renewal. 0 = new registration, non- | |
| | | | zero = renewal. | |
| PlanChangeFlag | Int | | A flag that indicates this payment was | Yes |
| | | | for a pricing plan adjustment. That is | |
| | | | the user changed his billing plan. | |
| | | | This could be the difference between | |
| | | | his old plan and new plan based on | |
| | | | the percentage of his old plan that | |
| | | | was used. | |
| StateSalesTaxAmount | float | 8 | The amount of the total that should | No |
| | | | be applied to the state tax. | |
| CountySalesTaxAmount | float | 8 | The amount of the total that should | No |
| | | | be applied to the county tax. | |
| CitySalesTaxAmount | float | 8 | The amount of the total that should | No |
| | | | be applied to the city tax. | |

As indicated above, an important aspect of the present invention is the use thereof as a fundraising vehicle. The database management system described herein allows an ADMINISTRATOR to establish fundraiser accounts. He/she will enter the percentage of a new registration that will be paid to the fundraiser when a new consumer registers using a “Promotion Code” associated with the particular fundraiser.

Any payments or terms negotiated between a fundraiser coordinator and the ADMINISTRATOR is not based on the system of the present invention. That is, no payments to the fundraiser coordinator will be automatically generated via Authorized.Net. Instead, the ADMINISTRATOR must run a report after the fundraiser has ended and then manually reimburse the entity sponsoring the fundraiser according to the terms previously agreed upon.

In implementing the system, each fundraiser will have a unique fundraiser code (Promotion) that will be used during the promotion period. Assuming that the fundraiser is sponsored by a school, each student will have a student I.D. that is related to the fundraiser for tracking and recognition purposes. Typically, a representative from the school would register with the present system and set up the valid date range for the fundraiser and create a code for the current period. The school's representative involved with the fundraiser would receive instructions needed to direct persons to the ADMINISTRATOR's website to register. The fundraiser coordinator will assign each student their own specific “Student I.D.”.

The students would be expected to distribute information cards containing registration instructions and their I.D. preprinted on the card to friends and neighbors. When a friend or neighbor goes to the ADMINISTRATOR's website to register, he/she would enter the Student I.D. (also referred to as Promotion or Referral Code) which is recognized by the system during the registration process for tracking purposes. When this registration is billed, the payment will be associated with the particular school. At the end of the fundraiser, the school's coordinator and the ADMINISTRATOR will be able to run reports that can be used to determine how much should be paid over to the fundraising entity, e.g., the school per the prior understanding.

Later, should the fundraising coordinator wish to establish a new fundraiser for a later period, he/she can log into the site and create a new fundraiser for a newly-specified time period. Assuming that friends and neighbors of the students involved were pleased with the benefits derived from the earlier fundraiser and now want to support a second one, simply entering the fundraiser identification code causes their previous billing plan to be automatically renewed, thus simplifying the overall process.

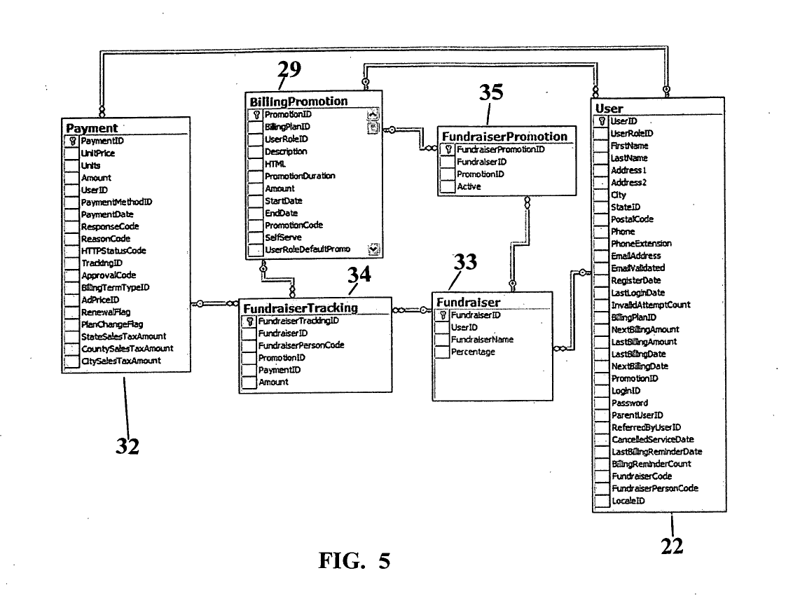

FIG. 5 comprise the database tables pertaining to the fundraising feature described above.

The Fundraiser table 33 is under control of the ADMINISTRATOR. As mentioned, any payments from Users who associate their registrations or user profiles with this fundraiser will be credited to that fundraiser.

| Column Name | Type | Size | Description | Required |
|---|---|---|---|---|
| FundraiserID | int | 4 | A system ID automatically | Yes |
| | | | generated when the new | |
| | | | fundraiser user is created. | |
| UserID | int | 4 | The User who is the coordinator | Yes |
| | | | for the school or sports team. | |
| FundraiserName | varchar | 80 | The name of the fundraiser. | Yes |
| Percentage | float | 8 | The percentage of the total | Yes |
| | | | registration fee that will be given to the | |
| | | | fundraiser. | |

The Fundraiser Tracking table 34 is established such that when a payment is made that matches the dates of the fundraiser, a record is added to this table.

| Column Name | Type | Size | Description | Required |
|---|---|---|---|---|
| FundraiserTrackingID | int | 4 | A system ID generated when a | Yes |
| | | | payment is made and associated | |
| | | | with this fundraiser | |
| FundraiserID | int | 4 | The fundraiser associated with a | Yes |
| | | | payment. | |
| FundraiserPersonCode | varchar | 20 | The student or athlete selling the | Yes |
| | | | fundraiser for the school or sports | |
| | | | team. | |
| PromotionID | int | 4 | The promotion identifier | Yes |
| | | | associated with registration. | |
| PaymentID | int | 4 | The payment ID from the payment | Yes |
| | | | table that is associated with this | |
| | | | fundraiser and person. This can | |
| | | | be used to get the person's name | |
| | | | who helped the school out by | |
| | | | participating in the fundraiser. | |
| Amount | float | 8 | This is the total payment amount. | Yes |
| | | | It can be adjusted by the | |
| | | | administrator if necessary. But in | |
| | | | the normal use case, it will match | |
| | | | the total payment amount from the | |
| | | | payment referred to by the | |
| | | | PaymentID in the previous field. | |

The Fundraiser Promotion table 35 finds the association between a fundraiser account and a particular promotion. Only one promotion can be active at one time.

| Column Name | Type | Size | Description | Required |
|---|---|---|---|---|
| FundraiserPromotionID | int | 4 | Unique ID selected by the system | Yes |
| | | | when a new promotion is | |
| | | | associated with a fundraiser | |
| FundraiserID | int | 4 | The fundraiser associated with a | Yes |
| | | | promotion | |
| PromotionID | int | 4 | The promotion associated with | Yes |
| | | | fundraiser | |
| Active | int | 4 | 0 = not active, 1 = active. Only | Yes |
| | | | one promotion per fundraiser can | |
| | | | be active at once. | |

In addition to adapting the coupon distribution system of the present invention to fundraising activities as earlier described, the system further lends itself to charitable giving. Charities are somewhat similar to fundraisers, but with a few functional differences. Rather than tracking the users who sell registrations to the system, MEMBERs will be given an opportunity to determine how the charitable giving of the ADMINISTRATOR is allocated. The allocation percentage will be defined and may be changed by the ADMINISTRATOR. The ADMINISTRATOR of the system determines the overall percentage of registration fees that will be donated to charitable organizations. Of that amount, MEMBERs are given the opportunity to allocate how that is distributed amongst the charities supported in the system. For example, say the ADMINISTRATOR sets forth the rule that 10% of registration fees will be given to charities. Further, say that an individual MEMBER's registration fee is $15.00. The total amount to be given as a charitable donation equates to $1.50 ($15.00×0.1=$1.50). Finally, the allocation and distribution of that amount between the charities is calculated based on the MEMBER's preferences. Say the MEMBER allocated 33% to each of three charities in the system. Each charity would receive $0.50 from that MEMBER's allocation of the overall $1.50. All charitable donations are manually calculated based on reports generated by the system. The system does not automatically generate payments to charitable organizations.

The distribution to charities is recorded in the consumer's profile, and each subsequent year, their renewal fees are automatically split between the various charities.

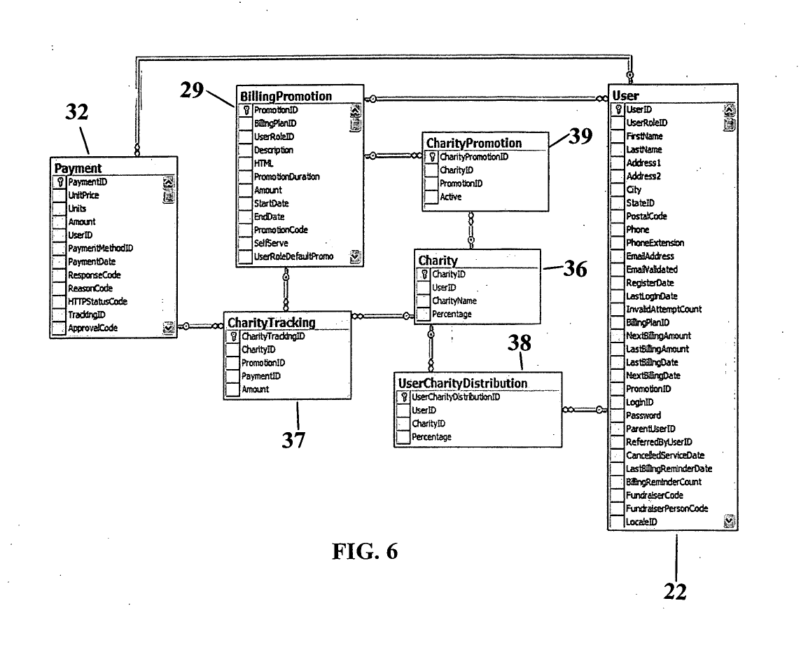

The database tables pertaining to charitable giving are shown in FIG. 6. The Charity table 36 in FIG. 6 contains data maintained by the ADMINISTRATOR. Any payments from users who associate their registrations or user profiles with the charity will be credited to that charity.

| Column Name | Type | Size | Description | Required |
|---|---|---|---|---|
| CharityID | int | 4 | A system ID automatically | Yes |
| | | | generated when the new Charity | |
| | | | user is created. | |
| UserID | int | 4 | The User who is the coordinator | Yes |
| | | | for the school or sports team. | |
| CharityName | varchar | 80 | The name of the Charity. | Yes |
| Percentage | float | 8 | The percentage of the total registration fee | Yes |
| | | | that will be given to the Charity. | |

The Charity Tracking table 37 is utilized such that when a payment is made that matches the dates of the charity event, a record is added to this table.

| Column Name | Type | Size | Description | Required |
|---|---|---|---|---|
| CharityTrackingID | int | 4 | A system ID generated when a | Yes |
| | | | payment is made and associated with this | |
| | | | Charity | |
| CharityID | int | 4 | The Charity associated with a | Yes |
| | | | payment. | |
| PromotionID | int | 4 | The promotion identifier | Yes |
| | | | associated with registration. | |
| PaymentID | int | 4 | The payment ID from the payment | Yes |
| | | | table that is associated with this | |
| | | | Charity and person. This can be | |
| | | | used to get the person's name | |
| | | | who helped the school out by | |
| | | | participating in the Charity. | |
| Amount | float | 8 | This is the total payment amount. | Yes |
| | | | It can be adjusted by the | |
| | | | administrator if necessary. But in | |
| | | | the normal use case, it will match | |
| | | | the total payment amount from the payment | |
| | | | referred to by the | |
| | | | PaymentID in the previous field. | |

The User Charity Distribution table 38 in FIG. 6 defines the association between a user and a charity.

| Column Name | Type | Size | Description | Required |
|---|---|---|---|---|
| UserCharityDistributionID | int | 4 | Unique ID selected by the system | Yes |
| | | | when a user decides to distribute | |
| | | | all or part of his registration fee to | |
| | | | a Charity | |
| UserID | int | 4 | The User associated with a | Yes |
| | | | charity. | |
| CharityID | int | 4 | The Charity associated with a user | Yes |
| Percentage | float | 8 | This is the total percentage | Yes |
| | | | amount of the user's registration | |
| | | | fee that will be split to this charity. | |

The differences between how charities and fundraisers are handled can be discerned from the respective tables of FIGS. 5 and 6 but for convenience are set out in the following comparison table which is not itself a system database table.

| Feature | Fundraiser | Charity |
|---|---|---|
| Track which user sold a | Yes - This is the key | No - Charities drive users |
| registration to a consumer. | attribute of fundraisers. | to the Administrator's site |
| | They typically want to | from their web site or other |
| | know which of the | advertising. |
| | members of the fundraiser | |
| | performed the best to | |
| | award prizes etc. | |
| Allow Automatic Yearly | No - If a fundraiser | Yes - Charitable donations |
| Charitable Contributions | renews next year, the | will automatically renew |
| based on percentage of | Members of the fundraiser | each year based on the |
| registration fee | will need to “resell” a | distribution percentage of a user. |
| | registration with the | |
| | system to an existing user | |
| Users will be able to add | No | Yes |
| additional donation to a | | |
| yearly registration fee | | |

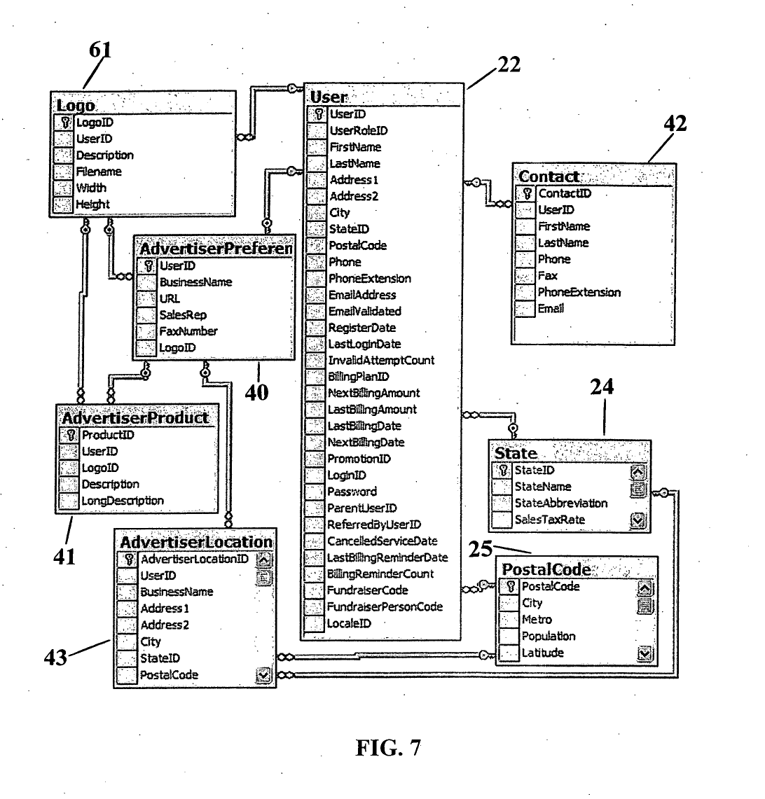

As used herein and as set forth on page 4, supra, ADVERTISERS are users in the system who wish to offer incentives, such as money-off coupons to MEMBERS who have registered themselves on the system and that have the ability to access those coupons and make hard copies thereof. Certain data only pertains to ADVERTISERS and, therefore, are not stored in the User table 22. Specifically, ADVERTISERS may differ from other users in that they may have multiple contact persons and multiple locations associated with their respective business. They may have multiple products associated with their business. Further, specific fields, such as business name, URL, fax number and logo are unique to users having ADVERTISER roles. FIG. 7 illustrates the relational database tables implementing the special data tracking associated with the ADVERTISER role.

The User table 22, the Postal Code table 25, and the State table 24 have already been defined and will not be repeated here. The Advertiser Preference table 40 stores data specific to ADVERTISER users in the system.

| Column Name | Type | Size | Description | Required |
|---|---|---|---|---|
| UserID | int | 4 | UserID stored in the User table | Yes |
| | | | for Advertiser User | |
| BusinessName | varchar | 80 | Name of the business | Yes |
| URL | varchar | 1024 | The URL to the business web site. | No |
| SalesRep | int | 4 | The sales rep who signed up this advertiser. | No |
| FaxNumber | varchar | 20 | The fax number for the corporate | No |
| | | | head quarters. | |
| LogoID | int | 4 | The logo for the business. See the later | No |
| | | | section on logos. | |

The Advertiser Product table 41 lists the products that a particular ADVERTISER wishes users to see when they view information about such products.

| Column Name | Type | Size | Description | Required |
|---|---|---|---|---|
| ProductID | int | 4 | System generated ID representing | Yes |
| | | | this product | |
| UserID | int | 4 | Advertiser related to this product | Yes |
| Description | varchar | 80 | The description of the product | Yes |
| LogoID | int | 4 | The logo for the business. See the | No |
| | | | later section on logos. | |
| Long Description | varchar | 1024 | A long description of product so the user | No |
| | | | can see more details. | |

The Contact table 42 merely stores information about contact persons at an ADVERTISER's business location.

| Column Name | Type | Size | Description | Required |
|---|---|---|---|---|
| ContactID | int | 4 | System generated ID | Yes |
| | | | representing this person | |
| UserID | int | 4 | Advertiser related to | Yes |
| | | | this person | |
| FirstName | varchar | 30 | First Name of the contact | Yes |
| LastName | varchar | 50 | Last Name of the contact | Yes |
| Phone | varchar | 10 | Phone number for this | Yes |
| | | | contact | |
| Fax | varchar | 50 | Fax number for this | No |
| | | | contact | |
| PhoneExtension | varchar | 10 | Phone extension for | No |
| | | | this contact | |
| Email | varchar | 80 | Email Address for this | No |
| | | | contact | |

The Advertiser Location table 43 presumes that a particular ADVERTISER has multiple store locations that can be listed so that all zip codes can be searched when a user performs a distance-based search for coupons or ADVERTISERs. The particulars of the table 43 are set forth below.

| Column Name | Type | Size | Description | Required |
|---|---|---|---|---|
| AdvertiserLocationID | int | 4 | System generated ID representing this | Yes |
| | | | location. | |
| UserID | int | 4 | Advertiser related to this location | Yes |
| Address1 | varchar | 80 | Address of this location | Yes |
| Address2 | varchar | 80 | Second line address of this location | No |
| City | varchar | 80 | City for this location | Yes |
| StateID | int | 4 | State of this location | Yes |
| PostalCode | varchar | 10 | Postal code for this location | Yes |
| Phone | varchar | 10 | Phone number for this location. | Yes |

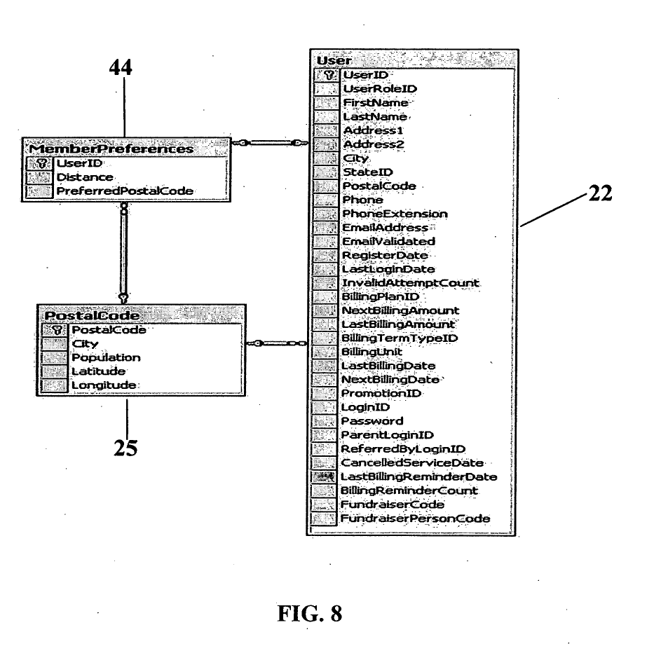

As reflected in FIG. 8, and especially the Member Preference table 44, MEMBERS who search for coupons have special data requirements to store their preferred zip code and distance from a perspective ADVERTISER's place of business.

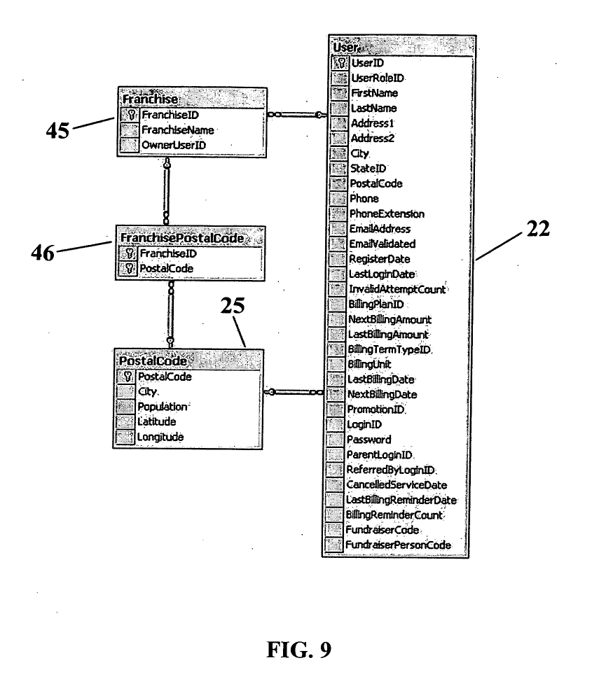

The system of the present invention lends itself to the possibility of franchising the coupon distribution system. Specifically, the ADMINISTRATOR is in a position to sell zip code ranges to entrepreneurs in other locations that may wish to start on-line businesses. FIG. 9 shows the relational database tables by which a franchisor may set up franchisees in different geographic areas.

The system of the present invention is designed such that ADVERTISERs are able to set up coupons in line with the membership limits to which they have subscribed. So, for example, if an ADVERTISER has a maximum coupon limit of three, the system will insure that only three coupons can be active at any given them. ADVERTISERs at their own workstations are able to design coupons to start and end after their next billing date. The system assumes that ADVERTISERs renew for a subsequent month, quarter, year for which they earlier signed up. Should an ADVERTISER cancel or if an automatic payment from that ADVERTISER does not get made for a specified number of days after their expected billing date, all of their coupons will be set to end on the day of their cancellation or final payment failure.

The system further allows ADVERTISERs to set up print limits on their coupons. If no limit is set, MEMBERs are able to print an unlimited number of coupons for the particular offer. With “per day” limits, MEMBERs can print only a designated number of coupons per day. For example, if a 1 is placed in the limit field, every MEMBER registered on the system can print this coupon once per day. The system allows limits to be placed on a per week, a per month or a per coupon basis. In the latter event, registered MEMBERs may print X number of coupons per offer. That is, if the ADVERTISER placed a 1 in the limit field with this type, every MEMBER of the system could print this coupon only once, no matter how long the coupon remains valid.

The system also allows the ADVERTISER to print the maximum value that the coupon is worth. For example, in a buy one get one free offer, it is possible to place a dollar limit, e.g., a maximum value of, say, $10.00.

Under the rules of the database system involved herein, businesses may fall into designated categories, such as dining, dry cleaning, floral, etc. Those categories may further be designated on a hierarchical basis where dining is broken down into fine dining and fast food establishments.

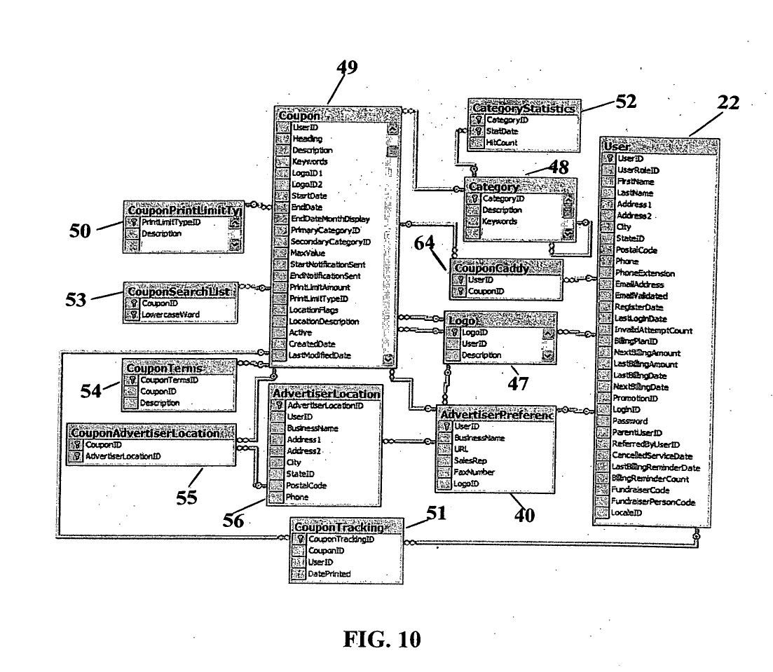

FIG. 10 illustrates the Relational database tables relating to the creation and distribution of promotional coupons and the following table describes the data stored in the tables of FIG. 10. The “User” and “Advertiser Preference” tables 22 and 40, respectively, have already been described and will not be repeated. Further, the Logo table 47 will be described in detail herein below. It may be noted, here, however, that a coupon can be associated with a logo for a product and a logo for an ADVERTISER.

The Category table 48 is such that an ADMINSTRATOR has a User Interface to maintain the table 48 and the relationship between categories and subcategories.

| Column Name | Type | Size | Description | Required |
|---|---|---|---|---|
| CategoryID | int | 4 | System generated ID | Yes |
| | | | representing | |
| | | | this category. | |
| | | | The user does not | |
| | | | choose this value | |
| Description | varchar | 80 | The Description of | Yes |
| | | | the category. | |
| ParentCategoryID | int | 4 | If this is a sub category, | Yes |
| | | | this field points to the | |
| | | | parent. For example, | |
| | | | if this is “Fast Food”, | |
| | | | the Parent CategoryID | |
| | | | would be the CategoryID | |
| | | | for “Dining”. | |

The Coupon table 49 is used to hold all of the information about an ADVERTISER's coupon. The table below further describes the individual's entries in the Coupon table 49.

| Column Name | Type | Size | Description | Required |
|---|---|---|---|---|
| CouponID | int | 4 | This is a system ID generated | Yes |
| | | | when a coupon is created | |
| UserID | int | 4 | This is the UserID of the advertiser | Yes |
| | | | who set the coupon up. | |
| Heading | varchar | 80 | This is a short description of the | Yes |
| | | | coupon. It will appear in the lists | |
| | | | about this coupon | |
| Description | varchar | 512 | This is the description that the | Yes |
| | | | user will see about the coupon | |
| | | | when requesting details. | |
| Keywords | varchar | 120 | This string is a set of keywords the | Yes |
| | | | merchant desires to have | |
| | | | associated with a coupon. These | |
| | | | keywords will be part of the search | |
| | | | list for coupons | |
| LogoID1 | int | 4 | This is the first of 2 options logos | No |
| | | | associated with this coupon. | |
| LogoID2 | int | 4 | This is the second of 2 options | No |
| | | | logos associated with this coupon. | |
| EndDateMonthDisplay | int | 4 | This setting allows the merchant to | No |
| | | | control the start and expiration | |
| | | | dates printed on the coupon. That | |
| | | | is, the display dates can be | |
| | | | different than the actual start and | |
| | | | end date stored with the coupon. | |
| | | | NULL = Print dates exactly as | |
| | | | shown in the Start and End Date | |
| | | | fields. | |
| | | | 0 = Display the 1st of the current | |
| | | | month as the start date and the | |
| | | | last day of the current month as | |
| | | | the end date. | |
| | | | 1 = Display the 1st of the current | |
| | | | month as the start date and the | |
| | | | last day of next month as the end | |
| | | | date. | |
| | | | For all date display rules, if the | |
| | | | start date is greater than the 1st | |
| | | | day of the month, the actual start | |
| | | | date will display. If the end date of | |
| | | | the actual coupon is less than the | |
| | | | last day of the current month, the | |
| | | | actual end date of the coupon will | |
| | | | display. | |
| StartDate | datetime | 8 | This is the date this coupon is | Yes |
| | | | active. If the advertiser does not | |
| | | | specify a date in the future, this | |
| | | | coupon will be active as of the day | |
| | | | the advertiser sets it up. | |
| EndDate | datetime | 8 | This is the end date of the coupon. | No |
| | | | If it is null (not specified), the | |
| | | | coupon does not expire. This field | |
| | | | is set to the date the advertiser | |
| | | | cancels service or cannot pay his | |
| | | | membership. | |
| PrimaryCategoryID | int | 4 | This is the primary category | Yes |
| | | | associated with this coupon. It is | |
| | | | required | |
| SecondaryCategoryID | int | 4 | This is a secondary category and | No |
| | | | is optional. | |
| MaxValue | float | 8 | This is the maximum amount in | No |
| | point | | US Dollars of the discount | |
| | | | associated with the coupon. If null | |
| | | | (not specified) either the text | |
| | | | determines the maximum value or | |
| | | | there is no need to specify. | |
| StartNotificationSent | int | 4 | A flag that indicates if the email | Yes |
| | | | notification has been sent. This is | |
| | | | only needed if the advertiser sets | |
| | | | up a coupon to start in the future. | |
| EndNotificationSent | int | 4 | A flag that indicates if the email | Yes |
| | | | notification has been sent when | |
| | | | the coupon ends. | |
| PrintLimitAmount | int | 4 | This is a numeric value that is | No |
| | | | used in conjunction with the | |
| | | | PrintLimitTypeID field to determine | |
| | | | what limits are placed on members | |
| | | | for usage of this coupon. If not | |
| | | | set, there is no limit | |
| PrintLimitTypeID | int | 4 | This is what type of limit. It can be | No |
| | | | daily, weekly, monthly, no limit, per | |
| | | | coupon. If not set, there is no | |
| | | | limit. | |
| LocationFlags | int | 4 | This is a set of flags that | Yes |
| | | | determines what location | |
| | | | information will print on the | |
| | | | coupon: | |
| | | | 1.) Only the list of valid locations. | |
| | | | 2.) Only the location description | |
| | | | (below) will print on the coupon. | |
| | | | 3.) Both the locations and the | |
| | | | description will print. | |
| LocationDescription | varchar | 80 | This is an option description that | No |
| | | | can be used in place of a valid | |
| | | | location list. An example is “Valid | |
| | | | at all locations”. | |
| Active | int | 4 | A flag that indicates if this coupon | Yes |
| | | | is currently active. Instead of | |
| | | | deleting the coupon from the | |
| | | | database, the system will | |
| | | | inactivate it to remove it from user | |
| | | | searches. | |
| CreatedDate | datetime | 8 | The date the coupon was created | Yes |
| | | | by the merchant. | |
| LastModifiedDate | datetime | 8 | The date the coupon was last | Yes |
| | | | edited by the merchant. | |

By providing a date display option and automatic date rollover feature, the ADVERTISER is allowed to select how the system will display the start and end dates on the coupon to the user. For example, an ADVERTISER can create a coupon offer that does not have an expiration date, but display a month end date on the coupon to create a sense of urgency for the consumer. The ADVERTISER may choose to display a month end date from 1 to 4 months out. When this feature is utilized, the start and end date displayed on the coupon will automatically rollover each month without requiring the ADVERTISER to manually change the dates. The automatic date rollover feature also works if a specific end date is chosen. In this case, the end

| Column Name | Type | Size | Description | Required |
|---|---|---|---|---|
| PrintLimitTypeID | int | 4 | This is a System ID that | Yes |
| | | | is used as a FK into the | |
| | | | Coupon table discussed | |
| | | | above. | |
| Description | varchar | 50 | This is the description | Yes |
| | | | of the Limitation Type. | |

date will not rollover past the specific end date selected.

Turning next to the Coupon Print Limit Type table 50, it is a System table that will not have a User Interface to update its values. Limit types include “no limit”, “daily”, “weekly”, “monthly” and “per coupon”. This table is used to determine how many coupons MEMBERs are allowed to print for any individual offer.

| Column Name | Type | Size | Description | Required |
|---|---|---|---|---|
| CouponTrackingID | int | 4 | This is a system generated ID | Yes |
| | | | that uniquely identifies the | |
| | | | tracking record. | |
| CouponID | int | 4 | This is the coupon that was | Yes |
| | | | printed. | |
| UserID | int | 4 | This is the member who printed | Yes |
| | | | the coupon. | |
| DatePrinted | datetime | 8 | This is the date and time the | Yes |
| | | | coupon was printed | |
| TrackingID | varchar | 32 | This is a user friendly ID that was | Yes |
| | | | generated by the system that | |
| | | | allows advertisers to track | |
| | | | individual coupons in the system. | |

The Category Statistics table 52 tracks how many times a category was “clicked” after the user searched for categories.

| Column | | | | |
|---|---|---|---|---|
| Name | Type | Size | Description | Required |
| CategoryID | int | 4 | This is the category that | |
| | | | was clicked. | |
| StatDate | datetime | 8 | This is the date the | |
| | | | category was clicked. | |
| HitCount | int | 4 | This is the total click count | |
| | | | for the date. | |

The Coupon Search List table 53 tracks the useful words in the coupon. Only such useful words will be used when looking for a match in a search operation. Noise words, such as “the”, “an”, etc., are excluded.

| Column Name | Type | Size | Description | Required |
|---|---|---|---|---|
| CouponID | int | 4 | The coupon this word is associated | Yes |
| | | | with. | |
| LowercaseWord | varchar | 80 | The word associated with the | Yes |
| | | | coupon. The system will take all | |
| | | | words used in the Heading, | |
| | | | Description and category | |
| | | | descriptions to compile a unique | |
| | | | list of none-trivial words to be used | |
| | | | during searching. For example, | |
| | | | let's say the Heading for a coupon was | |
| | | | “A test”. The description was | |
| | | | “Test description” and the category | |
| | | | description was “the test category”. | |
| | | | The list of none-trivial lowercase | |
| | | | words for this coupon would be: | |
| | | | test | |
| | | | description | |
| | | | category | |
| | | | Note that even though test | |
| | | | appears in the heading, | |
| | | | description and category, it only | |
| | | | appears in this table once for this | |
| | | | coupon. | |

The Coupon Terms table 54 contains a list of conditional terms that the merchant has associated with this coupon. For example, the merchant may specify that the coupon is “good” Monday through Thursday only. The present system will allow a merchant to associate any number of free format terms and conditions with a coupon.

| Column Name | Type | Size | Description | Required |
|---|---|---|---|---|
| CouponTermsID | int | 4 | Unique ID assigned by | Yes |
| | | | the system for this term. | |
| CouponID | int | 4 | The coupon this term is | Yes |
| | | | associated with. | |
| Description | varchar | 80 | The text for the term | Yes |
| | | | or condition. | |

Built into the system of the present invention is the ability to allow ADVERTISERs on the web page of the ADMINSTRATOR at a price negotiated between the ADVERTISER and the ADMINISTRATOR. While their paid membership fees will cover coupons offered in the system, if they desire to purchase advertising space in an effort to steer business to their website, they can do so. The system is designed so that ad space is reserved on the right-hand side of the main search screen. There can be as many ads as ADVERTISERs purchase. The site will simply scroll vertically when there are more ads that can appear in the standard search area.

The ADMINISTRATOR can control the pricing structure of ad space on the basis that the days, weeks, months, etc. that the ad will appear on the front page of the site. The system is configured such that the ADVERTISER will be billed for the ad commitment agreed upon upfront. The ADVERTISER may then decide when the ad will begin running and other details such as its graphical content and a destination URL where the user may browse after clicking on the ad.

A further key attribute that an ADVERTISER can choose is the “priority” of this ad. The priority ranges from: “Standard Priority” where no surcharge is added, “High Priority” involving a 10% surcharge and a “Top Priority” involving a 25% surcharge. The order in which ads of different ADVERTISERs are presented is determined by priority, length of commitment and the date entered into the system.

All Top Priority ads will sort to the top of the list followed by High Priority ones and, finally, Standard Priority ads. Within each priority, ads with a longer commitment sort to the top. Lastly, within that group, ads signed up earlier will sort higher than ads purchased later.

The system permits the ADMINISTRATOR to adjust the priority of a running ad as a way to give special ADVERTISERs a perk. Each time a MEMBER clicks on an ad, the system will record the date and time of the event for recording purposes.

The ADMINISTRATOR and ADVERTISER will be able to run reports of ad activity in the system.

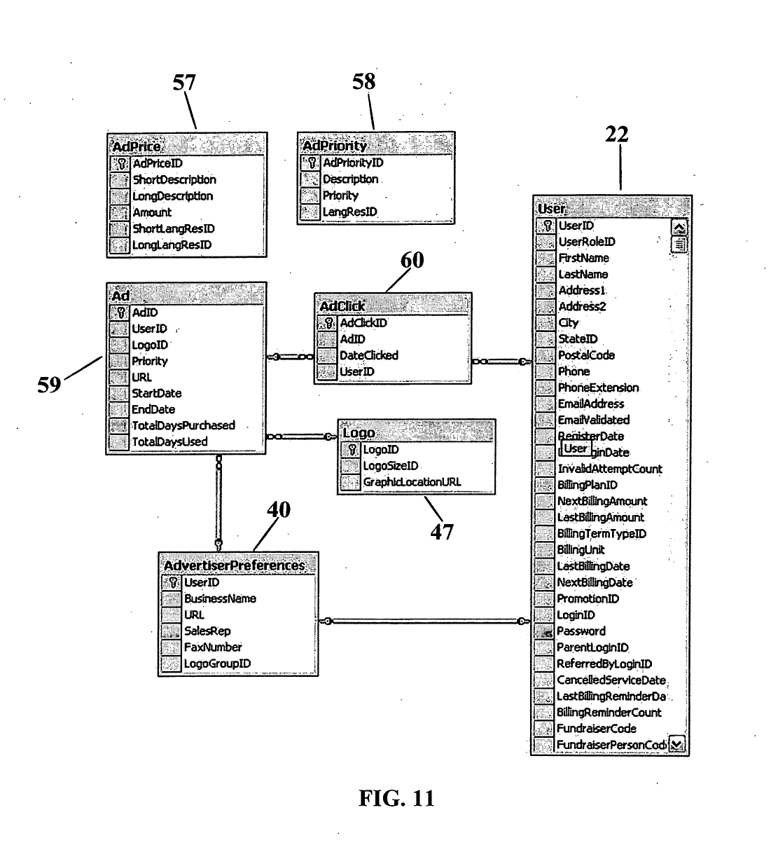

FIG. 11 illustrates the relational database tables involved in implementing the advertising function just described. The Ad Price table 57 in FIG. 11 determines the basic pricing options available to ADVERTISERs for the ad system feature. The ADMINISTRATOR of the system is able to determine the price for each entry in the table, but is not able to add new entries because this would change system behavior and require additional programming.

The following table describes the data stored in the various tables of FIG. 11 that have not already been described in connection with earlier tables.

| Column Name | Type | | Description | Required |
|---|---|---|---|---|
| AdPriceID | int | 4 | This is the system ID for an ad | Yes |
| | | | price. | |
| ShortDescription | varchar | 10 | This is a short description of the ad | Yes |
| | | | price options. Examples are Days, | |
| | | | Weeks, Months and Years. | |
| LongDescription | varchar | 30 | This is a longer description of the ad price | Yes |
| | | | options and is used when the | |
| | | | advertiser is making his buying | |
| | | | decision. Examples are Per Day, | |
| | | | Per Week, Per Month, and Per Year. | |
| Amount | float | 8 | This is the amount to be charged when | Yes |
| | | | an advertiser chooses an ad commitment | |
| | | | of this duration. | |

The Ad Priority table 58 affords ADVERTISERs the opportunity to select values that determine the placement of their ad and the final pricing amount. The higher the priority of an ad, the more expensive it is. As mentioned above, Standard Priority ads do not have a surcharge, but High Priority and Top Priority ads will have a surcharge added to their basic commitment price selected from the Ad Price table 57.

| Column Name | Type | Size | Description | Required |
|---|---|---|---|---|
| AdPriorityID | int | 4 | This is a system ID for | Yes |
| | | | the Ad Priority. | |
| Description | varchar | 50 | This is the description for | Yes |
| | | | the system value. Examples | |
| | | | are Standard, High, Top | |
| Priority | int | 4 | This is a numeric value that | Yes |
| | | | helps the system sort the | |
| | | | ads in the system. | |

The Ad table 59 in FIG. 11 is the table that stores the actual ads placed by ADVERTISERS in the system. The entries in this table are further explained in the following table.

| Column Name | Type | Size | Description | Required |
|---|---|---|---|---|
| AdID | int | 4 | This is a system generated ID that | Yes |
| | | | uniquely identifies the ad record. | |
| UserID | int | 4 | The UserID of the advertiser who | Yes |
| | | | placed the ad. | |
| LogoID | int | 4 | The logo associated with this ad. | Yes |
| Priority | int | 4 | The priority selected by the | Yes |
| | | | advertiser. This is a variable in the | |
| | | | final price paid by the advertiser for | |
| | | | placing the ad. | |
| URL | varchar | 1024 | The URL location that the member | Yes |
| | | | is taken to when they click the ad. | |
| StartDate | datetime | 8 | This is the date this ad is active. If | No |
| | | | the advertiser does not specify a | |
| | | | date in the future, this coupon will | |
| | | | be active as of the day the | |
| | | | advertiser sets it up. If the | |
| | | | advertiser temporarily suspends the | |
| | | | ad, this can be null. If so, the ad | |
| | | | will not show on the front page, the | |
| | | | amount of TotalDaysUsed will be | |
| | | | calculated so that when the | |
| | | | advertiser reactivates the ad, the | |
| | | | EndDate can be calculated. | |
| EndDate | datetime | 8 | This date is calculated by adding | No |
| | | | the start date together with the | |
| | | | TotalDaysPurchased − TotalDaysUsed. | |
| TotalDaysPurchased | int | 4 | This is calculated in based on the | Yes |
| | | | total number of Units purchased. | |
| | | | Weeks, Months and Years are | |
| | | | converted to days prior to storing | |
| | | | this field. | |
| TotalDaysUsed | int | 4 | If the advertiser suspends the ad, | Yes |
| | | | the amount used is calculated and | |
| | | | stored here to be used to calculate | |
| | | | the end date when they reinstate | |
| | | | the ad. | |

The Ad Click table 60 tracks who clicked an ad, when it was clicked and what particular ad was clicked. The table below further particularizes the entries in the Ad Click table 60.

| Column Name | Type | Size | Description | Required |
|---|---|---|---|---|
| AdClickID | int | 4 | This is a system ID | Yes |
| | | | generated when an | |
| | | | ad is clicked | |
| AdID | int | 4 | This is the ad clicked | Yes |
| DateClicked | datetime | 8 | This is the date and | Yes |
| | | | time the ad was | |
| | | | clicked. | |
| UserID | int | 4 | This is the user who | Yes |
| | | | clicked the ad. | |

The Logo table shown in FIG. 11 will be explained in detail later on in this specification.

Another capability of the system of the present invention is to allow MEMBERs to search for words in the descriptions of several tables in the system, including the Coupon table, the Category table, the Advertiser table and the Advertiser Product table.

Because the database system of the present invention needs to be optimized for searching, allowing users to search the description fields in these tables proves very inefficient. Simply stated, one needs to be do a case insensitive search, which means that one needs to run a function that turns the descriptions being searched to lower case prior to the execution of the SQL search. SQL or Structured Query Language is used to communicate with a database. It is the standard language for relational database management systems. In that a search word can appear in any part of the description, the SQL query needs to use the LIKE operator which itself can be very inefficient. However, because the search string can be found anywhere in the description, one needs to place a wild card matching character on each side of the word being searched. This is also very inefficient. Without a search optimization in place, the system would simply slow to a crawl as soon as several dozen people logged on and did some intensive searching. The optimization involved herein requires that:

1. For each description and keyword being saved into the system, the string will first be made to all lowercase.

2. The string will be broken in words;

3. All simple words, like, “a”, “an”, “the”, “in”, “are”, “to”, etc. will be removed; and

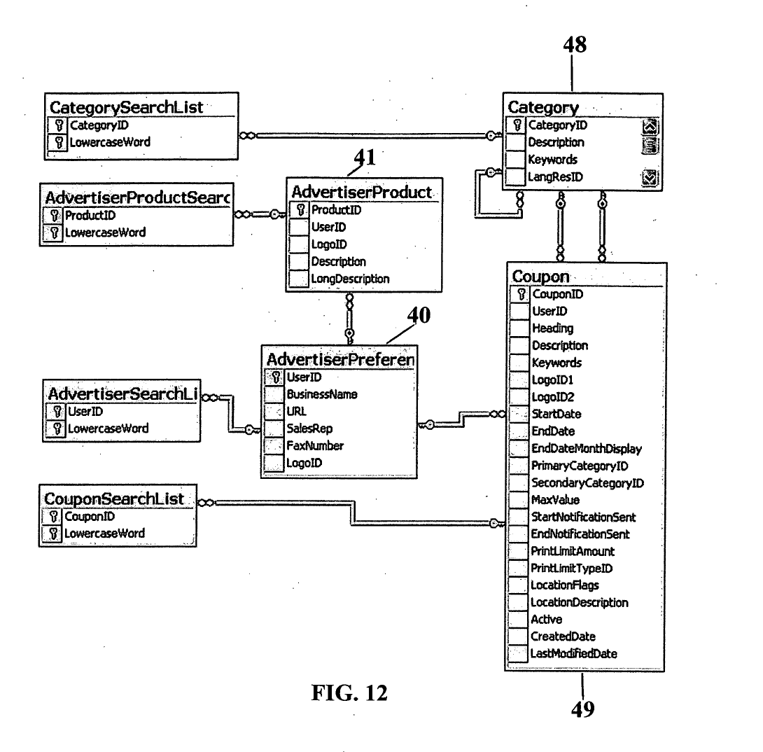

4. Any word not currently in the search list for a description will be saved in the corresponding Search List table as shown in the Relational Database table of FIG. 12.

When a MEMBER attempts to search for words within one of the descriptions in the system, the process is reversed:

1. The search string will first be made to all lowercase;

2. The string will be broken into words;

3. All simple words will be removed; and

4. The words in the search string will be compared to the normalized words in the Search List table to return the objects in the system matching the string.

In order to customize coupons and/or advertising to individuals who are registering in the ADVERTISER role, the system of the present invention will allow such ADVERTISERs to upload their business logo and any product logos for inclusion on coupons that are to be distributed to persons registered on the system as MEMBERS. The system permits each ADVERTISER to select up to two images to be included with a coupon which typically will comprise a product trademark and a business trade name.

When uploading logos to the system, a maximum width of 180 pixels and a maximum height of 90 pixels are set as limits. For .JPG files, the system of the present invention is able to resize logos larger than the stated maximums. The proper aspect ratio for the logos is maintained upon resizing.

The system operates to uniquely identify logos so that when merchants upload new versions of the same name file, the end-users will not have to “refresh” their browser cache to see the new logo. Because the new logo will have a new name, the browser will not have it in its cache.

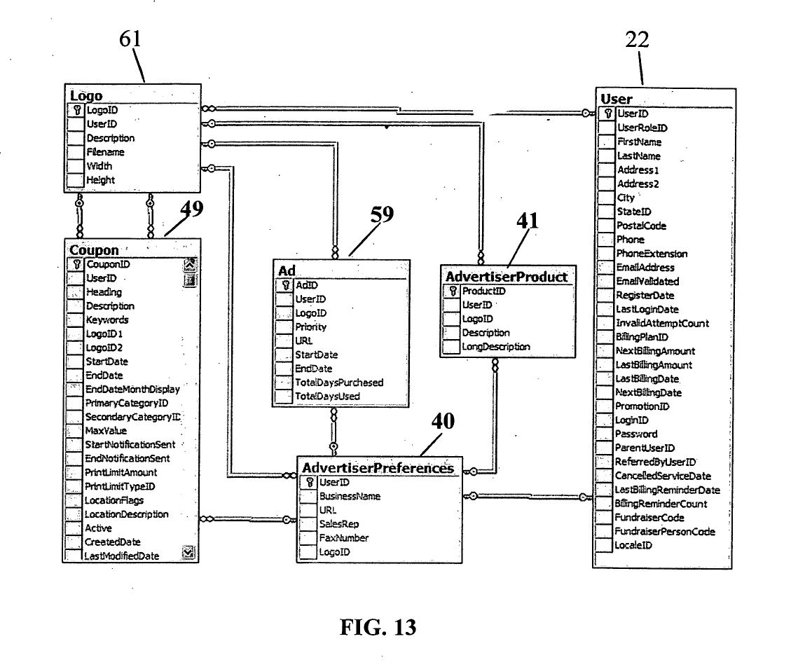

FIG. 13 illustrates the relational database implementing the logos and graphics features of the system.

The following table describes the data stored in the Logo table 61. The reader is referred to the previously-presented descriptions of the User table 22, the Advertiser Preference table 40, the Advertiser Product table 41, the coupon table 49 and the Ad table 59.

The Logo table 61 stores references to the graphics that ADVERTISERs upload to the system.

| Column Name | Type | Size | Description | Required |
|---|---|---|---|---|
| LogoID | int | 4 | This is a system generated ID that | |
| | | | uniquely identifies the logo | |
| | | | uploaded to the system. | |
| UserID | int | 4 | The owner of this logo. | Yes |
| Description | varchar | 80 | The user friendly description of this logo. | Yes |
| Filename | varchar | 40 | This is the unique name of the logo | Yes |
| | | | assigned by the system. It is used | |
| | | | when generating the html tags for | |
| | | | objects in the system that use this logo. | |
| Width | int | 4 | The width of the logo determined by | Yes |
| | | | the system when the logo was | |
| | | | uploaded. This is recorded and | |
| | | | used when generating the html tags. | |
| Height | int | 4 | The height of the logo determined | Yes |
| | | | by the system when the logo was | |
| | | | uploaded. This is recorded and | |
| | | | used when generating the html tags. | |

Those skilled in the art will appreciate that a barcode pattern can be treated as any other graphics and can be uploaded using the logo table 61 for storage thereof. Here, the system creates the barcode graphic based on a string of numbers or text and render it to .JPG based upon a font installed on the web server.

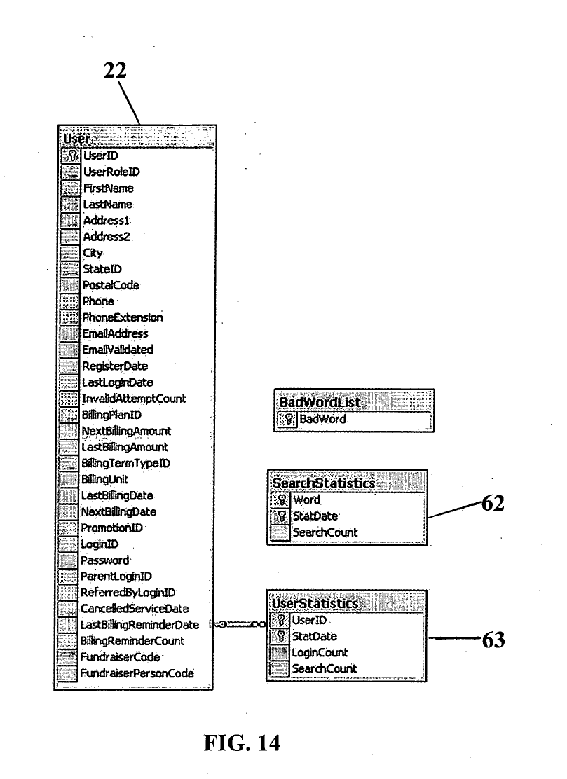

In order that ADMINISTRATORs and ADVERTISERs to gain an appreciation for how many times per day a search is made for businesses in specific categories, the system is able to collect statistics. More particularly, the system will track how many times a given user has logged into the system by date. This will show how many times per day a user returns to the system in any given day. It also provides a history by day for each individual that visits the system. See the User Statistics table 63 in FIG. 14.

Another feature is that the system will track the words used in searches by date. For example, if the word “Free” was used in a search, it would add “free” to the Statistics table 62 in FIG. 14. Then, each time the word “free” is used in a search for that day, the search count is updated by 1.

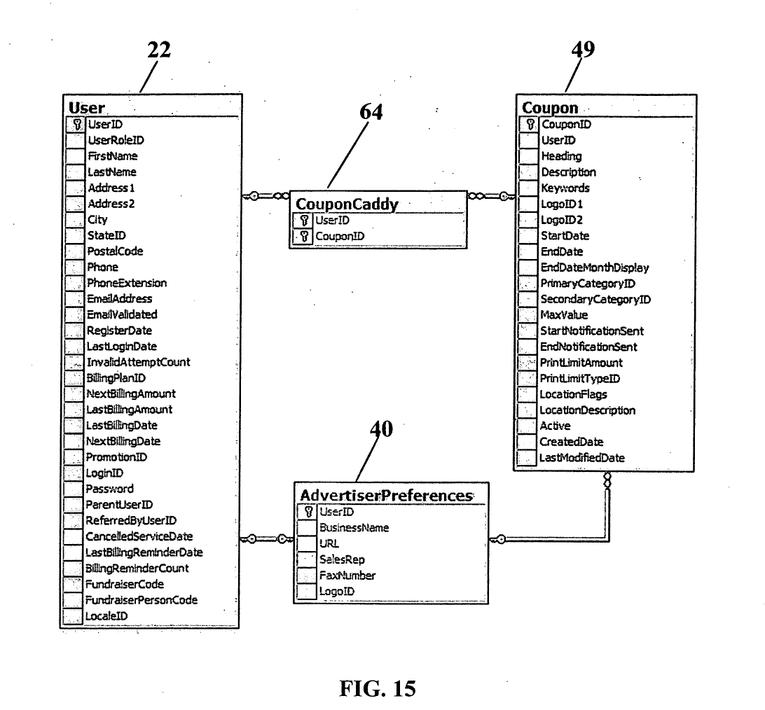

In the same way that many consumers who avail themselves of coupon offers printed in newspaper ads and direct mail pieces will collect coupons in an envelope or other folder and organize them before visiting a merchant's establishment, the system of the present invention provides a virtual equivalent referred to herein as the “Coupon Caddy” feature. FIG. 15 shows the tables comprising the relational database system for implementing this Coupon Caddy functionality. Effectively, over a period of time, a given MEMBER may access several ADVERTISER coupon offers and store them until such time as the MEMBER wishes to print them out in advance of visiting the ADVERTISER's business place. When viewing a coupon, a MEMBER has the option to either print the individual coupon or save the coupon to his/her Coupon Caddy. Implementation of the Coupon Caddy feature allows logged-in users to save their favorite coupons for easy reference and the option to select multiple coupons to print all at once versus printing each coupon individually. The following table more particularly describes the data entries in the Coupon Caddy table 64 in FIG. 15.

| Column Name | Type | Size | Description | Required |
|---|---|---|---|---|
| UserID | int | 4 | The user associated with a | Yes |
| | | | coupon. | |
| CouponID | int | 4 | The coupon to be added to the | Yes |
| | | | user's favorite list. | |

As a further feature of the present invention, the system has the ability to send e-mail notifications to users. Such e-mail messages include:

E-Mail Address Validation.

After registration, the user's e-mail address is validated by sending them a verification URL. Users cannot login until they have validated the address.

Payment Processing Success.

After a payment has successfully been processed by Authorized.Net, this e-mail will notify the user of the transaction. This will show the user what they have been billed for, their billed amount, any sales tax and totals. This is the electronic version of a receipt or invoice.

Payment Processing Failed.

If a payment has been failed by Authorized.Net, this e-mail will notify the user of the transaction. It will tell the user the reason that the payment failed and direct him/her back to the site to fix the problem.

Forgotten Password.

If the user has forgotten his/her password, the system will generate a new password for the user and send it to him/her via e-mail.

Payment Account Expired.

Periodically the system needs to check for credit cards that are due to expire and direct their owners back to the system so that they can update their information prior to a payment failing.

Coupons Starting.

If an ADVERTISER has set up coupons to start in the future, this e-mail notification will remind them that MEMBERs will start printing them. This will help them train their staff on what coupons are valid and how to identify coupons generated from the system.

Coupons Expiring.

When a coupon is going to expire, the system will notify the ADVERTISER and prompt him to renew the coupon.

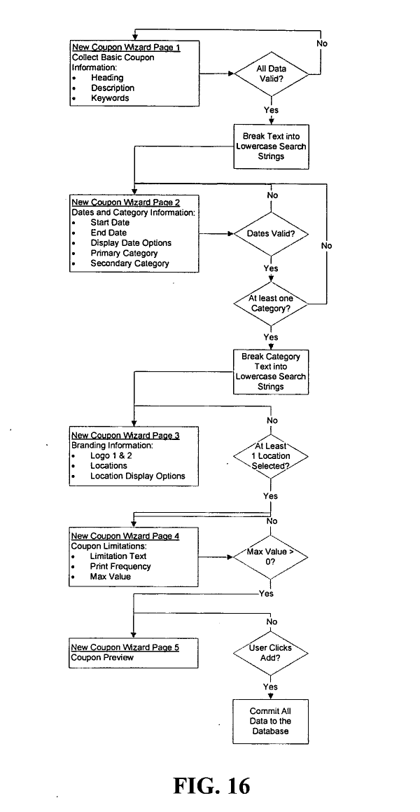

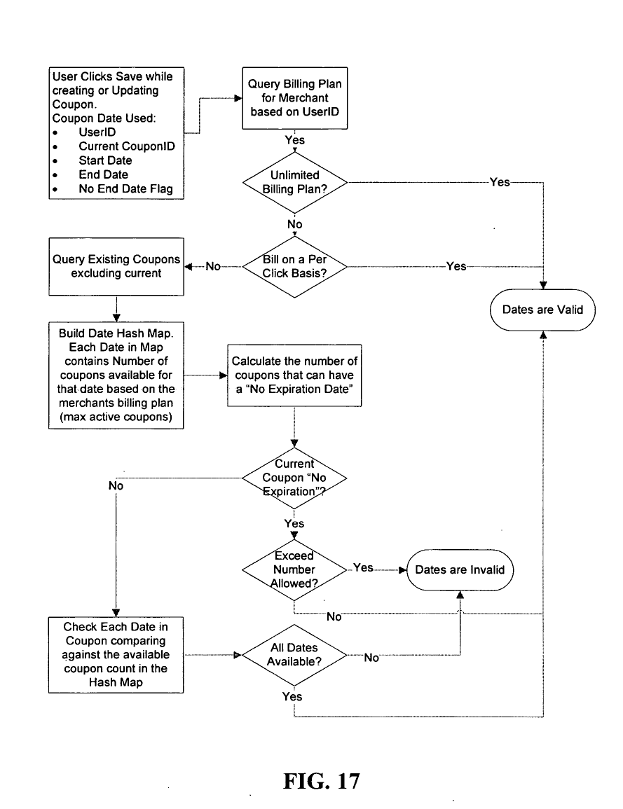

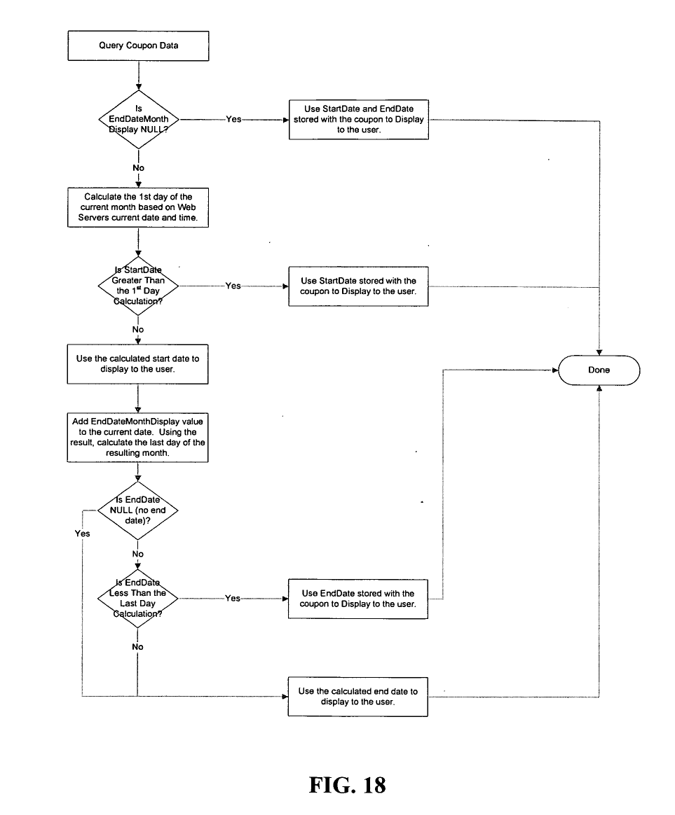

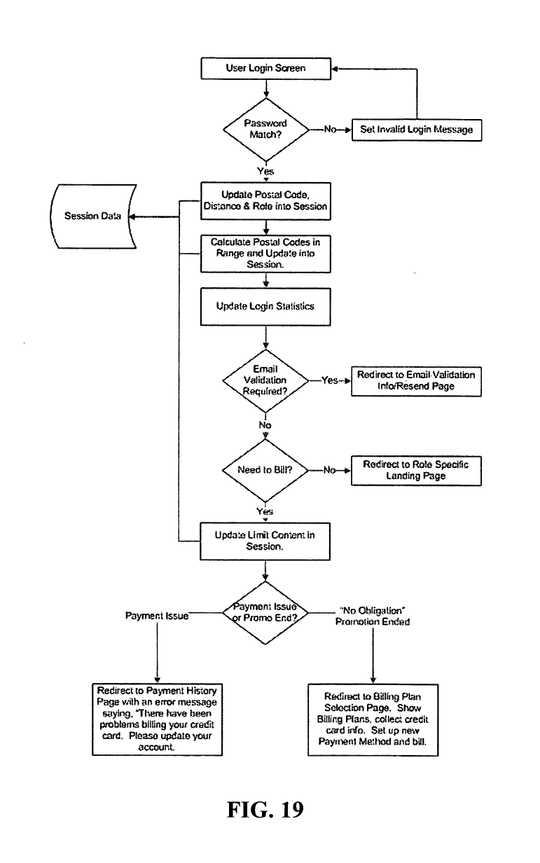

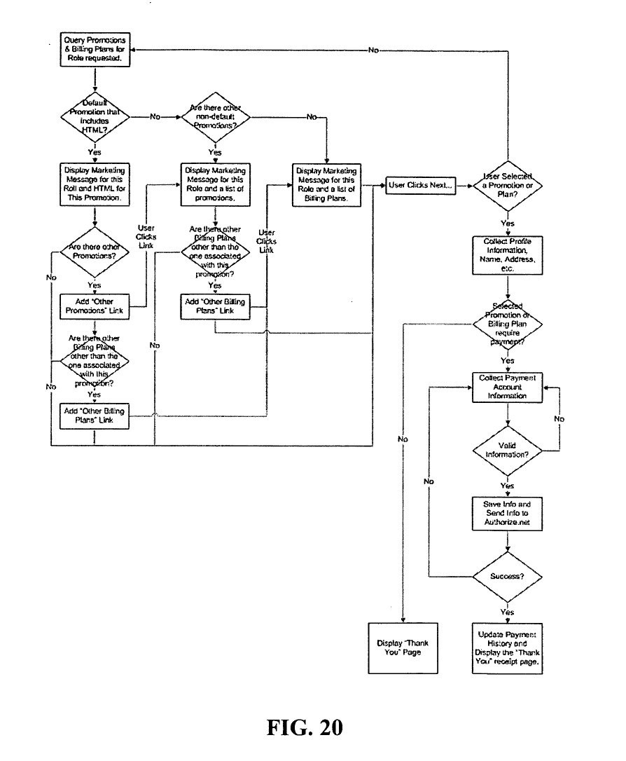

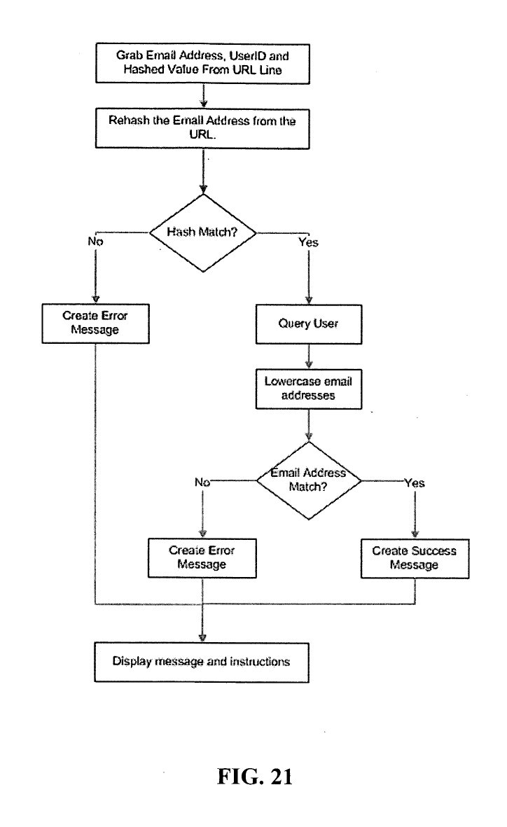

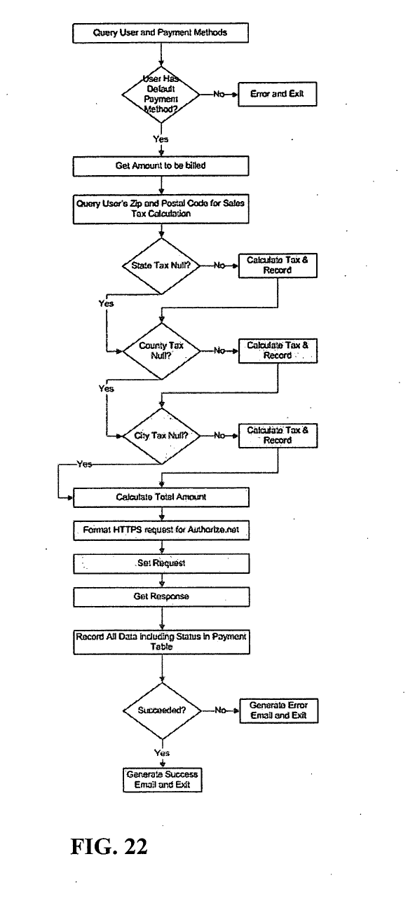

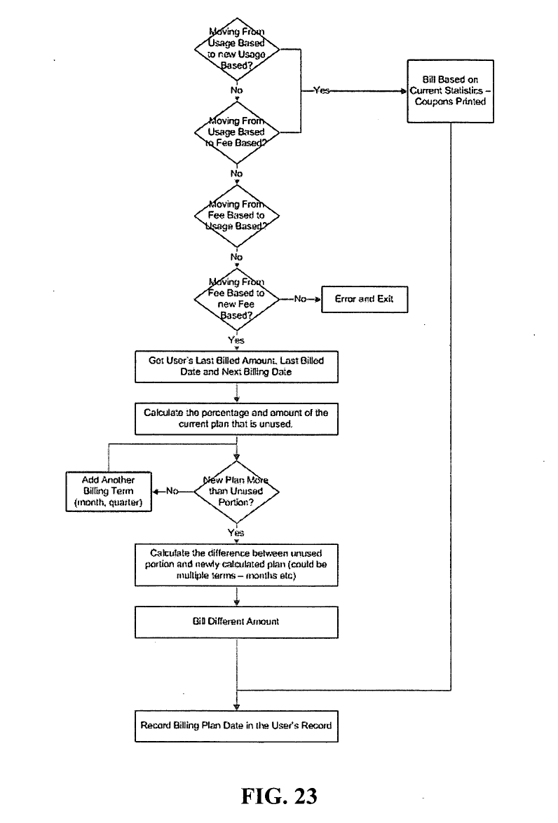

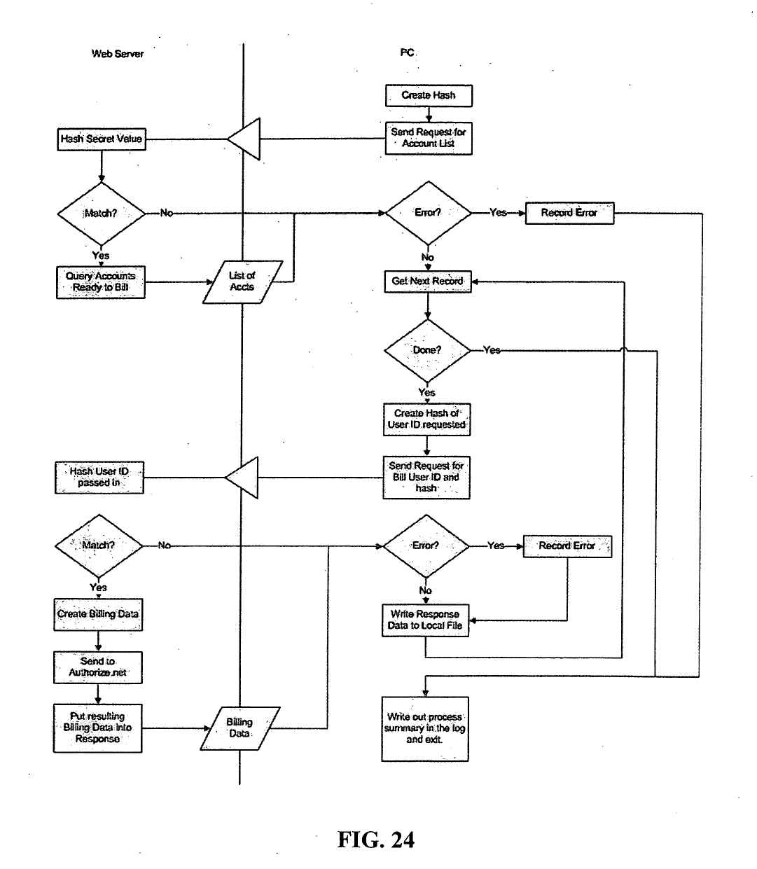

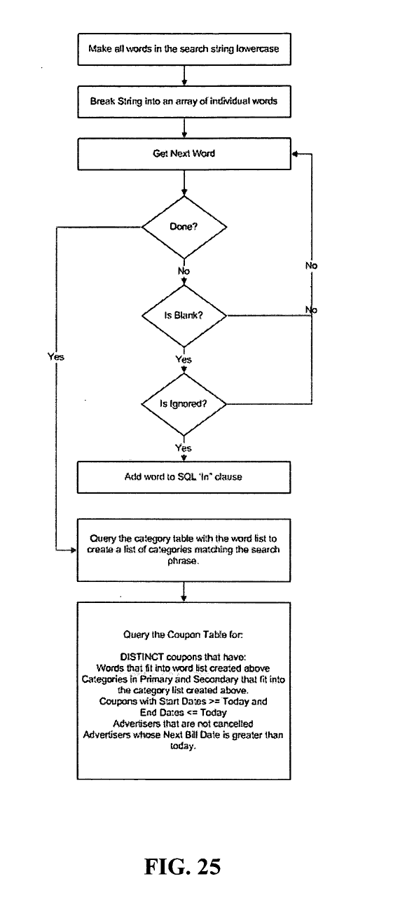

In order to fully comply with the disclosure requirements of the Patent Statute, included herein as FIGS. 16-26 are programming flow charts of the processes and algorithms implementing the automated coupon printing and distribution system of the present invention. These software flow diagrams should enable computer programmers of ordinary skill in the art and knowledgeable in database technology to write code in a currently available programming language which, when executed, will carry out the functionality as described herein.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A method of electronic production and distribution of promotional coupons comprising the steps of:
(a) providing a host computer with a network connection to a plurality of remotely-located workstations, the workstations being disposed at both merchant and customer locations;
(b) registering system users by providing a database in a storage medium accessable by the host computer, the database including a plurality of tables defining a set of screens viewable at the workstations and soliciting data to be entered by the system users including a login name, postal address, a password, an e-mail address, a user role I.D. indicative of whether a user is a merchant or a customer, and terms of a merchant's coupon offer entered into the database by a merchant to be electronically published; and
(c) storing in said database the data from completed screens for subsequent display and print-out of advertising coupons at a workstation of a registered customer.

2. The method as in claim 1 and further including the step of:
(a) a given customer selecting coupons of interest for inclusion in a further database at the host location assigned to that given customer.

3. The method as in claim 2 and further including the steps of:
(a) the given customer selecting coupons from the further database; and
(b) printing only the selected coupons at the workstation of said given customer.

4. The method as in claim 1 wherein the set of screens viewable at the workstations solicit further data for entry by system users that includes merchant's business type, merchant's business name, products/services of such businesses whereby a customer at a workstation can perform the step of searching the database for keywords and a geographic distance between a location of a merchant's facility and a customer's designated location related to said postal address.

5. The method as in claim 1 and further including the step performed by a merchant of uploading a custom logo into the database of the host computer whereby the logo will be printed out on coupons at the workstation of the registered customer.

6. The method of claim 1 wherein said solicited data further includes a selectable billing plan, billing frequency, and terms of each selectable billing plan.

7. The method of claim 6 wherein the solicited data further includes a selectable payment method.

8. The method of claim 1 wherein a first of the plurality of tables in said database holds information about a merchant's advertising coupon including a start date and an expiration date defining a period in which the coupon will be honored, and terms for coupon usage.
